(19) United States
(12) Patent Application Publication
(10) Pub. No.: US 2009/0082581 A1
(43) Pub. Date: Mar. 26, 2009

(54) Ferrocenyl ligands, production and use thereof

(76) Inventors: Benoit Pugin, Munchenstein (CH); Xiangdong Feng, Qingdao (CN)

Correspondence Address: WENDEROTH, LIND & PONACK, L.L.P., 2033 K STREET N. W., SUITE 800, WASHINGTON, DC, 20006-1021, US

(21) Appl. No.: 11/919,762

(22) PCT Filed: May 2, 2006
(86) PCT No.: PCT/EP2006/061973

§ 371 Date: Nov. 1, 2007

(30) Foreign Application Priority Data
May 3, 2005 (CH) 0776/05

(51) Int. Cl. C07F 17/02

(52) U.S. Cl. 549/206; 556/22; 556/145; 556/14

(57) ABSTRACT

The invention relates to the compounds of formula (I) in the form of enantiomer-pure diastereomers or a mixture of diastereomers, wherein R′₁ represents C₁-C₄ alkyl, C₆-C₁₀ aryl, C₇-C₁₀ alkyl or C₇-C₁₂ alkaralkyl and n is 0 or an integer of from 1 to 5; R₁ represents a hydrogen atom, halogen, a hydrocarbon group with 1 to 20 C atoms that is either unsubstituted or substituted with —SC₁-C₄ alkyl, —OC₁-C₄ alkyl, —OC₆-C₁₀ aryl or —Si(C₁C₄ alkyl)₃, or a silyl group with 3 C₁-C₁₂ hydrocarbon groups; Y represents vinyl, methyl, ethyl, —CH₂—OR, —CH₂—N(C₁-C₄ alkyl)₂, a C-bound chiral group that directs metals of metallation reagents to the ortho position X₁, or Y is a group —CHR₂—OR′₂; R₂ represents C₁-C₈ alkyl, C₅-C₈ cycloalkyl, C₆-C₁₀ aryl, C₇-C₁₂ aralkyl or C₇-C₁₂ alkaralkyl; R′₂ represents hydrogen or C₁-C₁₈ acyl; X₁ and X₂ independently represent a P-bound P(III) substituent, —SH or an S-bound group of mercaptan; and R represents hydrogen, a silyl group or an aliphatic, cycloaliphatic, aromatic or aromatic-aliphatic hydrocarbon group with 1 to 18 C atoms which is unsubstituted or substituted with C₁-C₄ alkyl, C₁-C₄ alkoxy, F or CF₃. The inventive compounds are ligands for metal complexes of transition metals such as Ru, Rh or Ir which are catalysts for especially the enantioselective hydration of prochiral unsaturated compounds. Use of these compounds allows to achieve high catalyst activities and an excellent stereoselectivity.

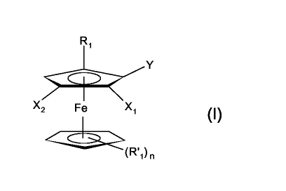

The present invention relates to ferrocenes substituted in the 1 position by a C-bonded radical and in the 2,3 positions by a P- or S-bonded radical, their preparation, complexes of transition metals (for example TM8 metals) with these ligands and the use of the metal complexes in the homogeneous, stereoselective synthesis of organic compounds.

Chiral ligands have proven to be extraordinarily important auxiliaries for catalysts in homogeneous stereoselective catalysis. The effectiveness of such catalysts is frequently found to be specific for particular substrates. To be able to achieve optimization for particular substrates, it is therefore necessary to have a sufficient number of chiral ligands available. There is therefore a continuing need for further efficient chiral ligands which are simple to prepare and give good results in stereoselective catalytic reactions. Ligands whose properties can be matched to and optimized for particular catalytic objectives are of particular interest. Ligands which can be built up in a modular fashion are particularly suitable for this purpose.

Ferrocene is a very useful basic skeleton for the preparation of ligands which has been used successfully for the provision of different substitutions with secondary phosphino radicals. Kagan et al. [(G. Argouarch, O. Samuel, O. Riant, J.-C. Daran, H. Kagan, Eur. J. Org. Chem. (2000) 2893-2899] have recently described novel ferrocene-1,2-diphosphines as ligands having the following basic structure, but these have only planar chirality:

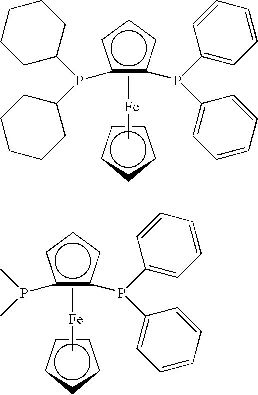

These ligands are difficult to prepare. Although the synthesis is modular per se, only the 2 representatives shown have been prepared up to now. In catalytic hydrogenations, they gave appropriate results in a few cases but without being convincing in terms of the stereoselectivity. These ligands are therefore relatively unsuitable for industrial use.

P,S-Ligands which are based on ferrocenes having planar chirality and are used in catalytic reactions are also known. Thus, for example, O. G. Mancheno et al., Organometallics 2005, 24 (4), pages 557 to 561, describe R-1-sec-phosphino-2-sulfinylferrocenes as ligands in Pd complexes which are efficient catalysts for Diels-Alder reactions.

It is also known that the metallation (by means of, for example, butyllithium) of ferrocenes having a chiral substituent such as 1-(dimethylamino)eth-1-yl proceeds stereoselectively in the ortho position relative to the chiral substituent. The metal can then be replaced in a manner known per se by halogen such as bromine. It has surprisingly been found that the hydrogen atom in the ortho position relative to the bromine atom can be metallated simply and very selectively by means of lithium bases and then be reacted with sec-phosphine halides. These monophosphines can then unexpectedly be converted into ferrocene-1,2-diphosphines by replacement of the bromine atom even though this position is strongly shielded sterically. It has also surprisingly been found that these ligands have significantly better stereoselectivities, especially in hydrogenations. In addition, these ligands are very modular and can be optimized for a given catalytic problem by variation of the chiral substituents and of the phosphines. The catalyst activities and conversions depend on the substrate used and range from good to very high (up to 100%).

The invention firstly provides compounds of the formula I in the form of enantiomerically pure diastereomers or a mixture of diastereomers,

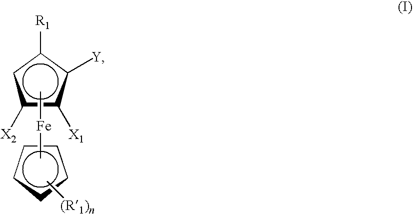

where
R′₁ is C₁-C₄-alkyl, C₆-C₁₀-aryl, C₇-C₁₂-aralkyl or C₇-C₁₂-alkaralkyl and n is 0 or an integer from 1 to 5;
R₁ is a hydrogen atom, halogen, an unsubstituted or —SC₁-C₄-alkyl-, —OC₁-C₄-alkyl-, —OC₆-C₁₀-aryl- or —Si(C₁-C₄-alkyl)₃-substituted hydrocarbon radical having from 1 to 20 carbon atoms or a silyl radical having 3 C₁-C₁₂-hydrocarbon radicals;
Y is vinyl, methyl, ethyl, —CH₂—OR, —CH₂—N(C₁-C₄-alkyl)₂ or a C-bonded chiral group which directs metals of metallating reagents into the ortho position X₁ or Y is a —CHR₂—OR′₂ group;
R₂ is C₁-C₈-alkyl, C₅-C₈-cycloalkyl, C₆-C₁₀-aryl, C₇-C₁₂-aralkyl or C₇-C₁₂-alkaralkyl;
R′₂ is hydrogen or C₁-C₁₈-acyl;
X₁ and X₂ are each, independently of one another, a P-bonded P(III) substituent, —SH or an S-bonded radical of a mercaptan; and
R is hydrogen, a silyl radical or an aliphatic, cycloaliphatic, aromatic or aromatic-aliphatic hydrocarbon radical which has from 1 to 18 carbon atoms and is unsubstituted or substituted by C₁-C₄-alkyl, C₁-C₄-alkoxy, F or CF₃.

For the purposes of illustration, the structure of the other enantiomer of the compound of the formula I is shown below:

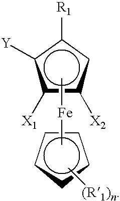

A hydrocarbon radical R can be, for example, alkyl, cycloalkyl, heterocycloalkyl, cycloalkylalkyl, heterocycloalkylalkyl, aryl, aralkyl, heteroaryl, heteroaralkyl having heteroatoms selected from the group consisting of O, S, —N═ and —N(C₁-C₄-alkyl), where cyclic radicals preferably contain from 5 to 7 ring atoms, alkyl preferably contains from 1 to 6 carbon atoms and “alkyl” in cyclic radicals preferably contains 1 or 2 carbon atoms. In a preferred embodiment, a hydrocarbon radical R is C₁-C₄-alkyl, C₅-C₆-cycloalkyl, C₆-C₁₀-aryl, C₇-C₁₂-aralkyl or C₇-C₁₂-alkaralkyl. Some examples of R are methyl, ethyl, n-propyl, n-butyl, cyclohexyl, cyclohexylmethyl, tetrahydrofuryl, phenyl, benzyl, furanyl and furanylmethyl.

An alkyl group R′₁ can be, for example, methyl, ethyl, n- or i-propyl, n-, i- or t-butyl, with preference being given to methyl. A C₆-C₁₀-aryl radical R′₁ can be naphthyl and in particular phenyl. A C₇-C₁₂-aralkyl radical R′₁ can preferably be phenyl-C₁-C₄-alkyl such as benzyl or phenylethyl. A C₇-C₁₂-alkaralkyl radical R′₁ can preferably be C₁-C₄-alkylbenzyl such as methylbenzyl. n is preferably 0 (and R′₁ is thus a hydrogen atom).

A halogen R₁ can be F, Cl, Br or I, preferably F or Cl.

A hydrocarbon radical R₁ preferably contains from 1 to 12, more preferably from 1 to 8 and particularly preferably from 1 to 4, carbon atoms. The hydrocarbon radicals can be C₁-C₄-alkyl, C₅-C₆-cycloalkyl, C₅-C₆-cycloalkyl-C₁-C₄-alkyl, phenyl or benzyl. The hydrocarbon radicals can contain substituents which are inert toward metallating reagents. Examples are C₁-C₄-alkyl, C₁-C₄-alkoxy, C₁-C₄-alkylthio, phenoxy and trimethylsilyl.

A silyl radical R or R₁ can contain identical or different hydrocarbon radicals and preferably corresponds to the formula R₀₁R₀₂R₀₃Si—, where R₀₁, R₀₂ and R₀₃ are each, independently of one another, C₁-C₁₈-alkyl, unsubstituted or C₁-C₄-alkyl- or C₁-C₄-alkoxy-substituted C₆-C₁₀-aryl or C₇-C₁₂-aralkyl. Alkyl radicals R₀₁, R₀₂ and R₀₃ can be linear or branched and the alkyl preferably contains from 1 to 12 and particularly preferably from 1 to 8 carbon atoms. Aryl radicals R₀₁, R₀₂ and R₀₃ can be, for example, phenyl or naphthyl and aralkyl radicals R₀₁, R₀₂ and R₀₃ can be benzyl or phenylethyl. Some examples of R₀₁, R₀₂ and R₀₃ are methyl, ethyl, n- or i-propyl, n-, i- or t-butyl, pentyl, hexyl, heptyl, octyl, nonyl, decyl, undecyl, dodecyl, phenyl, benzyl, methylphenyl, methylbenzyl, methoxyphenyl, dimethoxyphenyl and methoxybenzyl. Some preferred examples of silyl groups R₀₁R₀₂R₀₃Si— are trimethylsilyl, tri-n-butylsilyl, t-butyldimethylsilyl, 2,2,4,4-tetramethylbut-4-yldimethylsilyl and triphenylsilyl.

In a preferred embodiment, R₁ is H or, as alkyl, C₁-C₄-alkyl, particularly preferably methyl.

In the ortho-directing, chiral group Y, the chiral atom is preferably bound in the 1, 2 or 3 position relative to the cyclopentadienyl-Y bond. The group Y can be an open-chain radical or cyclic radical made up of H and C atoms and, if desired, heteroatoms selected from the group consisting of O, S, —N═ and —N(C₁-C₄-alkyl)-.

The group Y can, for example, correspond to the formula —HC*R₅R₆ (* denotes the chiral atom), where R₅ is C₁-C₈-alkyl, C₅-C₈-cycloalkyl(cyclohexyl), C₆-C₁₀-aryl(phenyl), C₇-C₁₂-aralkyl (benzyl) or C₇-C₁₂-alkaralkyl(methylbenzyl), R₆ is —OR₇ or —NR₈R₉, R₇ is C₁-C₈-alkyl, a silyl radical, C₅-C₈-cycloalkyl, phenyl or benzyl and R₈ and R₉ are identical or different and are each C₁-C₈-alkyl, C₅-C₈-cycloalkyl, phenyl or benzyl or R₈ and R₉ together with the N atom form a five- to eight-membered ring. R₅ is preferably C₁-C₄-alkyl such as methyl, ethyl, n-propyl and phenyl. R₇ is preferably C₁-C₄-alkyl such as methyl, ethyl, n-propyl and n- or i-butyl. A silyl radical R₇ is preferably tri(C₁-C₁₈-alkyl)silyl. R₈ and R₉ are preferably identical radicals and are preferably each C₁-C₄-alkyl such as methyl, ethyl, n-propyl, i-propyl and n- or i-butyl or together tetramethylene, pentamethylene or 3-oxa-1,5-pentylene.

Y is particularly preferably a —CHR₅—NR₈R₉ group, where R₅ is C₁-C₄-alkyl, C₅-C₆-cycloalkyl, phenyl, C₁-C₄-alkylphenyl or C₁-C₄-alkylbenzyl and R₈ and R₉ are identical and are each C₁-C₄-alkyl. Very particularly preferred groups of the formula —HCR₅R₆ are 1-methoxyeth-1-yl, 1-dimethylaminoeth-1-yl and 1-(dimethylamino)-1-phenylmethyl.

When Y is a chiral radical without an asymmetric a carbon atom, it is bound to the cyclopentadienyl ring via a carbon atom either directly or via a bridging group. The bridging group can be, for example, methylene, ethylene or an imine group. Cyclic radicals bound to the bridging group are preferably saturated and are particularly preferably C₁-C₄-alkyl-, (C₁-C₄-alkyl)₂NCH₂—, (C₁-C₄-alkyl)₂NCH₂CH₂—, C₁-C₄-alkoxymethyl- or C₁-C₄-alkoxyethyl-substituted N—, O— or N,O-heterocycloalkyl having a total of 5 or 6 ring atoms. Open-chain radicals are preferably bound to the cyclopentadienyl ring via a CH₂ group and the radicals are preferably derived from amino acids or ephedrine. Some preferred examples are:

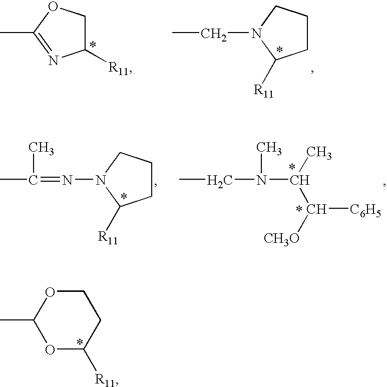

where R₁₁ is C₁-C₄-alkyl, phenyl, (C₁-C₄-alkyl)₂NCH₂—, (C₁-C₄-alkyl)₂NCH₂CH₂—, C₁-C₄-alkoxy-methyl or C₁-C₄-alkoxyethyl. R₁₁ is particularly preferably methoxymethyl or dimethylamino-methyl.

When Y is a —CHR₂—OR′₂ group, R₂ is preferably C₁-C₄-alkyl, C₅-C₆-cycloalkyl(cyclohexyl), phenyl, benzyl or methylbenzyl.

When Y is a —CHR₂—OR′₂ group, R′₂ is preferably hydrogen or C₁-C₁₈-alkyl-C(O)—, C₅-C₈-cycloalkyl-C(O)—, C₆-C₁₀-aryl-C(O)—, C₇-C₁₂-aralkyl-C(O)— or C₇-C₁₂-alkaralkyl-C(O)—. R′₂ is particularly preferably methyl-C(O)—.

In a particularly preferred embodiment, Y in the formula I is vinyl, methyl, ethyl, —CH₂—OR, —CH₂—N(C₁-C₄-alkyl)₂, —CHR₅—NR₈R₉ or —CHR₂—OR′₂, where

R₂ and R₅ are each, independently of one another, C₁-C₄-alkyl, C₅-C₆-cycloalkyl, phenyl, benzyl or methylbenzyl;
R′₂ is hydrogen or C₁-C₈-acyl or independently has the following meaning of R;
R₈ and R₉ are identical and are each C₁-C₄-alkyl; and
R is C₁-C₆-alkyl, tri(C₁-C₁₈-alkyl)silyl, C₅-C₆-cycloalkyl, C₅-C₆-cycloalkylmethyl, phenyl or benzyl and is unsubstituted or substituted by C₁-C₄-alkyl, C₁-C₄-alkoxy, F or CF₃.

In another preferred embodiment, R₁ is hydrogen and Y is a chiral or achiral ortho-directing group.

A P-bonded P(III) substituent X₁ and X₂ can be a secondary phosphino group which contains identical or different hydrocarbon radicals. X₁ and X₂ are preferably not identical but different.

The hydrocarbon radicals can be unsubstituted or substituted and/or contain heteroatoms selected from the group consisting of O, S, —N═ and N(C₁-C₄-alkyl). They can contain from 1 to 22, preferably from 1 to 12 and particularly preferably from 1 to 8, carbon atoms. A preferred secondary phosphino group is one in which the phosphino group contains two or identical or different radicals selected from the group consisting of linear or branched C₁-C₁₂-alkyl; unsubstituted or C₁-C₆-alkyl- or C₁-C₆-alkoxy-substituted C₅-C₁₂-cycloalkyl or C₅-C₁₂-cycloalkyl-CH₂—; phenyl, naphthyl, furyl or benzyl; and halogen, C₁-C₆-alkyl-, trifluoromethyl-, C₁-C₆-alkoxy-, trifluoromethoxy-, (C₆H₅)₃Si—, (C₁-C₁₂-alkyl)₃Si— or sec-amino-substituted phenyl or benzyl.

Examples of alkyl substituents on P, which preferably contain from 1 to 6 carbon atoms, are methyl, ethyl, n-propyl, i-propyl, n-butyl, i-butyl, t-butyl and the isomers of pentyl and hexyl. Examples of unsubstituted or alkyl-substituted cycloalkyl substituents on P are cyclopentyl, cyclohexyl, methylcyclohexyl and ethylcyclohexyl and dimethylcyclohexyl. Examples of alkyl- and alkoxy-substituted phenyl and benzyl substituents on P are methylphenyl, dimethylphenyl, trimethylphenyl, ethylphenyl, methylbenzyl, methoxyphenyl, dimethoxyphenyl, trimethoxyphenyl, trifluoromethylphenyl, bistrifluoromethylphenyl, tristrifluoromethylphenyl, trifluoromethoxyphenyl, bistrifluoromethoxyphenyl, fluorophenyl and chlorophenyl and 3,5-dimethyl-4-methoxyphenyl.

Preferred secondary phosphino groups are those containing identical or different radicals selected from the group consisting of C₁-C₆-alkyl, cyclopentyl and cyclohexyl which may be unsubstituted or substituted by from 1 to 3 C₁-C₄-alkyl or C₁-C₄-alkoxy radicals, benzyl and in particular phenyl which are unsubstituted or substituted by from 1 to 3 C₁-C₄-alkyl, C₁-C₄-alkoxy, C₁-C₄-fluoroalkyl or C₁-C₄-fluoroalkoxy, F and Cl.

The secondary phosphino group preferably corresponds to the formula —PR₃R₄, where R₃ and R₄ are each, independently of one another, a hydrocarbon radical which has from 1 to 18 carbon atoms and is unsubstituted or substituted by C₁-C₆-alkyl, trifluoromethyl, C₁-C₆-alkoxy, trifluoromethoxy, (C₁-C₄-alkyl)₂amino, (C₆H₅)₃Si, (C₁-C₁₂-alkyl)₃Si, and/or contains heteroatoms O.

R₃ and R₄ are preferably radicals selected from the group consisting of linear or branched C₁-C₆-alkyl, cyclopentyl or cyclohexyl which may be unsubstituted or substituted by from one to three C₁-C₄-alkyl or C₁-C₄-alkoxy radicals, furyl, benzyl which may be unsubstituted or substituted by from one to three C₁-C₄-alkyl or C₁-C₄-alkoxy radicals and in particular phenyl which may be unsubstituted or substituted by from one to three F, Cl, C₁-C₄-alkyl, C₁-C₄-alkoxy, C₁-C₄-fluoroalkyl or C₁-C₄-fluoroalkoxy radicals.

R₃ and R₄ are particularly preferably radicals selected from the group consisting of C₁-C₆-alkyl, cyclopentyl, cyclohexyl, furyl and phenyl which may be unsubstituted or substituted by from one to three F, Cl, C₁-C₄-alkyl, C₁-C₄-alkoxy and/or C₁-C₄-fluoroalkyl radicals.

When R₃ and R₄ in the —PR₃R₄ group are different, then the ligands are additionally P-chiral.

The secondary phosphino group can be cyclic secondary phosphino, for example a group of the formulae

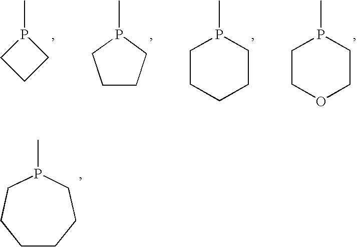

which are unsubstituted or substituted by one or more C₁-C₈-alkyl, C₄-C₈-cycloalkyl, C₁-C₆-alkoxy, C₁-C₄-alkoxy-C₁-C₄-alkyl, phenyl, C₁-C₄-alkylphenyl or C₁-C₄-alkoxyphenyl, benzyl, C₁-C₄-alkylbenzyl or C₁-C₄-alkoxybenzyl, benzyloxy, C₁-C₄-alkylbenzyloxy or C₁-C₄-alkoxybenzyloxy or C₁-C₄-alkylidenedioxyl radicals.

The substituents can be bound to the P atom in one or both a positions in order to introduce chiral carbon atoms. The substituents in one or both a positions are preferably C₁-C₄-alkyl or benzyl, for example methyl, ethyl, n- or i-propyl, benzyl or —CH₂—O—C₁-C₄-alkyl or —CH₂—O—C₆-C₁₀-aryl.

Substituents in the β,γ positions can be, for example, C₁-C₄-alkyl, C₁-C₄-alkoxy, benzyloxy or —O—CH₂—O—, —O—CH(C₁-C₄-alkyl)-O— and —O—C(C₁-C₄-alkyl)₂-O—. Some examples are methyl, ethyl, methoxy, ethoxy, —O—CH(methyl)-O— and —O—C(methyl)₂-O—.

Depending on the type of substitution and number of substituents, the cyclic phosphino radicals can be C-chiral, P-chiral or C- and P-chiral.

An aliphatic 5- or 6-membered ring or benzene can be fused onto two adjacent carbon atoms in the radicals of the above formulae.

The cyclic secondary phosphino group can, for example, correspond to one of the formulae (only one of the possible diastereomers is shown),

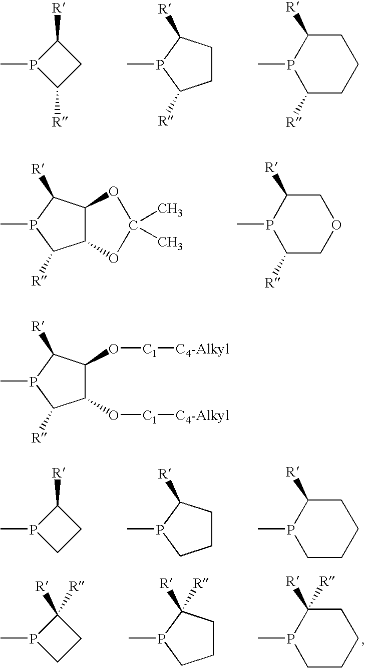

where
the radicals R′ and R″ are each C₁-C₄-alkyl, for example methyl, ethyl, n- or i-propyl, benzyl or —CH₂—O—C₁-C₄-alkyl or —CH₂—O—C₆-C₁₀-aryl, and R′ and R″ are identical or different.

In the compounds of the formula I, sec-phosphino radicals X₁ and X₂ are preferably each, independently of one another, acyclic sec-phosphino selected from the group consisting of —P(C₁-C₆-alkyl)₂, —P(C₅-C₈-cycloalkyl)₂, —P(C₇-C₈-bicycloalkyl)₂, —P(o-furyl)₂, —P(C₆H₅)₂, —P[2-(C₁-C₆-alkyl)C₆H₄]₂, —P[3-(C₁-C₆-alkyl)C₆H₄]₂, —P[4-(C₁-C₆-alkyl)C₆H₄]₂, —P[2-(C₁-C₆-alkoxy)C₆H₄]₂, —P[3-(C₁-C₆-alkoxy)C₆H₄]₂, —P[4-(C₁-C₆-alkoxy)C₆H₄]₂, —P[2-(trifluoromethyl)C₆H₄]₂, —P[3-(trifluoromethyl)C₆H₄]₂, —P[4-(trifluoromethyl)C₆H₄]₂, —P[3,5-bis(trifluoromethyl)C₆H₃]₂, —P[3,5-bis(C₁-C₆-alkyl)₂C₆H₃]₂, —P[3,5-bis(C₁-C₆-alkoxy)₂C₆H₃]₂ and —P[3,5-bis(C₁-C₆-alkyl)₂-4-(C₁-C₆-alkoxy)C₆H₂]₂, or a cyclic phosphino selected from the group consisting of

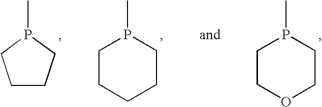

which is unsubstituted or substituted by one or more C₁-C₄-alkyl, C₁-C₄-alkoxy, C₁-C₄-alkoxy-C₁-C₂-alkyl, phenyl, benzyl, benzyloxy or C₁-C₄-alkylidenedioxyl radicals.

Some specific examples are —P(CH₃)₂, —P(i-C₃H₇)₂, —P(n-C₄H₉)₂, —P(i-C₄H₉)₂, —P(t-C₄H₉)₂, —P(C₅H₉), —P(C₆H₁₁)₂, —P(norbornyl)₂, —P(o-furyl)₂, —P(C₆H₅)₂, P[2-(methyl)C₆H₄]₂, P[3-(methyl)C₆H₄]₂, —P[4-(methyl)C₆H₄]₂, —P[2-(methoxy)C₆H₄]₂, —P[3-(methoxy)C₆H₄]₂, —P[4-(methoxy)C₆H₄]₂, —P[3-(trifluoromethyl)C₆H₄]₂, —P[4-(trifluoromethyl)C₆H₄]₂, —P[3,5-bis(trifluoromethyl)C₆H₃]₂, —P[3,5-bis(methyl)₂C₆H₃]₂, —P[3,5-bis(methoxy)₂C₆H₃]₂ and —P[3,5-bis(methyl)₂-4-methoxy)C₆H₂]₂ and groups of the formulae

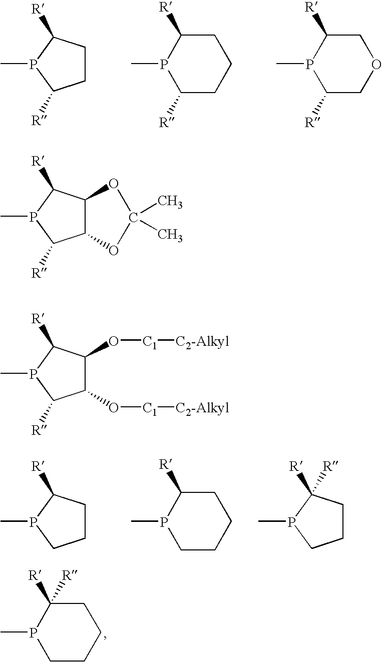

where
R′ is methyl, ethyl, methoxy, ethoxy, phenoxy, benzyloxy, methoxymethyl, ethoxymethyl or benzyloxymethyl and R″ has the same meanings as R′ and is different from R′.

P-Bonded P(III) substituents X₁ and X₂ can also be —PH₂ or —PHR₁₂. R₁₂ can be a hydrocarbon radical as mentioned above for secondary phosphino groups as P-bonded P(III) substituent, including the preferences.

P-bonded P(III) substituents X₁ and X₂ can each also be a phosphinite radical of the formula —PR₁₃OR₁₄, where R₁₃ and R₁₄ are each, independently of one another, a hydrocarbon radical as mentioned above for secondary phosphino groups as P-bonded P(III) substituent, including the preferences, or R₁₃ and R₁₄ together form a divalent hydrocarbon radical which has from 3 to 8 and preferably from 3 to 6 carbon atoms in the chain and is unsubstituted or substituted by C₁-C₄-alkyl, C₁-C₄-alkoxy, C₁-C₄-alkylthio, phenoxy or (C₁-C₄-alkyl)₃Si—. Aromatics such as benzene or naphthalene can be fused onto the divalent hydrocarbon radical.

P-Bonded P(III) substituents X₁ and X₂ can each also be a phosphonite radical of the formula —POR₁₅OR₁₆, where R₁₅ and R₁₆ are each, independently of one another, a hydrocarbon radical as mentioned above for secondary phosphino groups as P-bonded P(III) substituent, including the preferences, or R₁₅ and R₁₆ together form a divalent hydrocarbon radical which has from 2 to 8 and preferably from 2 to 6 carbon atoms in the chain and is unsubstituted or substituted by C₁-C₄-alkyl, C₁-C₄-alkoxy, C₁-C₄-alkylthio, phenoxy or (C₁-C₄-alkyl)₃Si—. Aromatics such as benzene or naphthalene can be fused onto the divalent hydrocarbon radical. When R₁₅ and R₁₆ together form a divalent hydrocarbon radical, the substituents are cyclic phosphonite groups.

This cyclic phosphonite group can be a five- to eight-membered ring in which the O atoms of the —O—P—O— group are bound in the α,ω positions to a C₂-C₅-chain which may be part of a biaromatic or biheteroaromatic ring. Carbon atoms of the cyclic phosphonite group can be unsubstituted or substituted, for example by C₁-C₄-alkyl, C₁-C₄-alkoxy, halogens (F, Cl, Br), CF₃ or —C(O)—C₁-C₄-alkyl. When the —O—P—O— group is bound to an aliphatic chain, the latter is preferably substituted or unsubstituted 1,2-ethylene or 1,3-propylene.

The cyclic phosphonite group can, for example, be formed by a substituted or unsubstituted C₂-C₄-alkylenediol, preferably C₂-diol, and correspond to the formula XI,

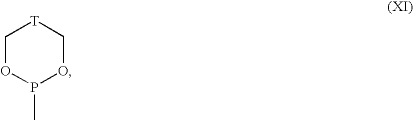

where T is a direct bond or an unsubstituted or substituted —CH₂— or —CH₂—CH₂—. T is preferably a direct bond and the cyclic phosphonite group is thus a phosphonite radical of the formula XIa,

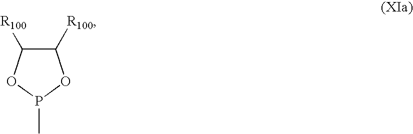

where R₁₀₀ is hydrogen, C₁-C₄-alkyl, phenyl, benzyl, C₁-C₄-alkoxy or the two radicals R₁₀₀ form an unsubstituted or substituted fused-on aromatic.

Other cyclic phosphonites can, for example, be derived from 1,1′-biphenyl-2,2′-diols and correspond to the formula XII,

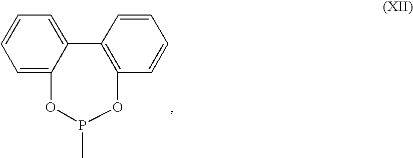

where each phenyl ring may be unsubstituted or bear from one to five substituents, for example halogen (F, Cl, Br), CF₃, C₁-C₄-alkyl, C₁-C₄-alkoxy or —C(O)—C₁-C₄-alkyl.

Other cyclic phosphonites can, for example, be derived from 1,1′-binaphthyl-2,2′-diols and correspond to the formula XIII,

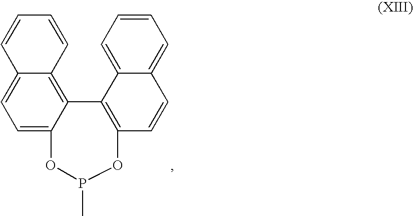

where each naphthyl ring may be unsubstituted or bear from one to six substituents, for example halogen (F, Cl, Br), CF₃, C₁-C₄-alkyl, C₁-C₄-alkoxy or —C(O)—C₁-C₄-alkyl.

Other cyclic phosphonites can, for example, be derived from 1,1′-biheteroaromatic-2,2′-diols and correspond to the formula XIV,

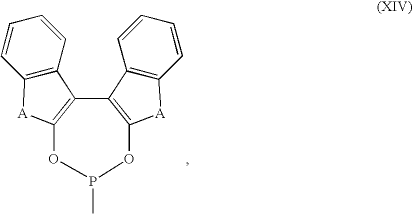

where each phenyl ring may be unsubstituted or bear from one to four substituents, for example halogen (F, Cl, Br), CF₃, C₁-C₄-alkyl, C₁-C₄-alkoxy or —C(O)—C₁-C₄-alkyl, and A is —O—, —S—, ═N—, —NH— or —NC₁-C₄-alkyl-.

P-Bonded P(III) substituents X₁ and X₂ can each also be an aminophosphine radical of the formula —PR₁₇NR₁₈R₁₉, where R₁₇, R₁₈ and R₁₉ are each, independently of one another, an open-chain hydrocarbon radical as mentioned above for secondary phosphino groups as P-bonded P(III) substituent, including the preferences, or R₁₇ has this meaning and R₁₈ and R₁₉ together form a divalent hydrocarbon radical which has from 3 to 7 and preferably from 4 to 6 carbon atoms and is unsubstituted or substituted by C₁-C₄-alkyl, C₁-C₄-alkoxy, C₁-C₄-alkylthio, phenyl, benzyl, phenoxy or (C₁-C₄-alkyl)₃Si—.

P-Bonded P(III) substituents X₁ and X₂ can each also be an aminophosphine radical of the formula —P(NR₁₈R₁₉)(NR₂₀R₂₁), where R₁₈, R₁₉, R₂₀ and R₂₁ have the meaning of an open-chain hydrocarbon radical R₁₇, including the preferences, or R₁₈ and R₁₉ together, R₂₀ and R₂₁ together or R₁₉ and R₂₀ together in each case form a divalent hydrocarbon radical which has from 3 to 7 and preferably from 4 to 6 carbon atoms and is unsubstituted or substituted by C₁-C₄-alkyl, C₁-C₄-alkoxy, C₁-C₄-alkylthio, phenyl, benzyl, phenoxy or (C₁-C₄-alkyl)₃Si—.

X₁ and X₂ can each be, independently of one another, —SH or an S-bonded hydrocarbon radical of a mercaptan which preferably has from 1 to 20, more preferably from 1 to 12 and particularly preferably from 1 to 8, carbon atoms. The S-bonded hydrocarbon radical of a mercaptan can correspond to the formula R₂₂S—, where R₂₂ is C₁-C₁₈-alkyl and preferably C₁-C₁₂-alkyl, C₅-C₈-cycloalkyl, C₅-C₈-cycloalkyl-C₁-C₄-alkyl, C₆-C₁₀-aryl, C₇-C₁₂-aralkyl or C₇-C₁₂-alkaralkyl, which are unsubstituted or substituted by F, trifluoromethyl, C₁-C₄-alkyl, C₁-C₄-alkoxy, C₁-C₄-alkylthio, phenyl, benzyl, phenoxy or (C₁-C₄-alkyl)₃Si—. Some examples of R₂₂ are methyl, ethyl, n-propyl, n-butyl, cyclohexyl, cyclohexylmethyl, phenyl, benzyl, phenylethyl and methylbenzyl.

The invention further provides a process for preparing compounds of the formula I, which comprises the steps:
a) reaction of a compound of the formula II

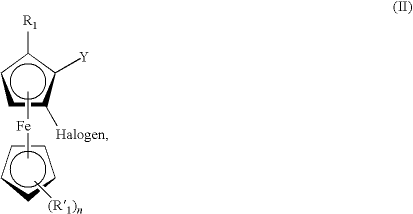

where
Y, R′₁, n and R₁ are as defined above, with the exception of Y=—CHR₂—OR′₂ and R′₂=acyl or hydrogen, and halogen is bromine or iodine, with at least equivalent amounts of an aliphatic lithium sec-amide or a halogen-Mg sec-amide to form a compound of the formula III,

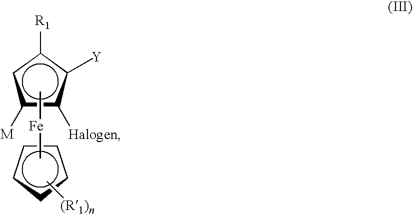

where M is Li or —MgX₃ and X₃ is Cl, Br or I,
b) reaction of a compound of the formula III with a compound of the formula Z₁-Halo, where Halo is Cl, Br or I and Z₁ is a P(III) substituent, or with sulfur or an organic disulfide to introduce the group X₂ and form a compound of the formula IV,

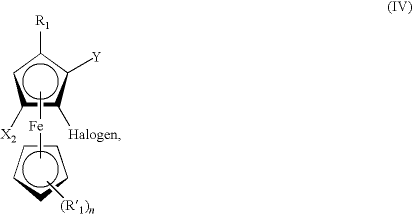

c) reaction of a compound of the formula IV with at least equivalent amounts of alkyllithium or a magnesium Grignard compound and then with at least equivalent amounts of a compound Z₂-Halo, where Halo is Cl, Br or I and Z₂ independently has one of the meanings of Z₁, or with sulfur or an organic disulfide to form a compound of the formula I,
d) and, to prepare compounds of the formula I in which Y is a —CHR₂—OR′₂ group and R′₂ is acyl or hydrogen, reaction of a secondary amino radical in the radical Y with a carboxylic anhydride (acetic anhydride) to form an acyloxy substituent and, if desired, hydrolysis to form a —CHR₂—OH group.

In the process, Y is not a —CHR₂—OR′₂ group in which R′₂ is hydrogen or acyl since these radicals give rise to undesirable secondary reactions. These groups are more advantageously introduced after metallation steps and introduction of the groups X₁ and X₂ by heating with carboxylic anhydrides to replace a —CHR₅—NR₈R₉ group by an acyloxy radical which can be hydrolyzed to form a hydroxyl group.

Compounds of the formula II are known or can be prepared by known methods or methods analogous to known methods. Known Y-substituted ferrocenes are used as starting materials and are metallated in the ortho position and then reacted with a halogenating reagent.

Compounds of the formula II in which Y is methyl, for example 1-methyl-2-bromoferrocene, are described by T. Arantani et al. in Tetrahedron 26 (1970), pages 5453-5464, and by T. E. Picket et al. in J. Org. Chem. 68 (2003), pages 2592-2599.

Compounds of the formula II in which Y is vinyl or ethyl can, for example, be prepared by elimination of amines from 1-[(dialkylamino)eth-1-yl]-2-haloferrocenes, for example 1-[(dimethylamino)eth-1-yl]-2-bromoferrocene of the formula

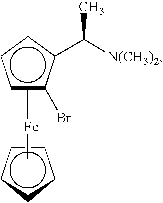

to form 1-vinyl-2-haloferrocene, preferably 1-vinyl-2-bromoferrocene, and, if desired, subsequent hydrogenation of the vinyl group formed to an ethyl group. The reaction conditions are described in the examples. In 1-[(dialkylamino)eth-1-yl]-2-haloferrocenes, the amino group can be replaced by acyloxy by reaction with carboxylic anhydrides and then replaced by another secondary amino group or by a radical —OR.

Compounds of the formula II in which Y is a —CH₂—N(C₁-C₄-alkyl)₂ group can be obtained, for example, by replacement of a quaternized CH₂-bonded chiral sec-amino radical by means of HN(C₁-C₄-alkyl)₂. Examples of such CH₂-bonded sec-amino radicals are those of the formulae

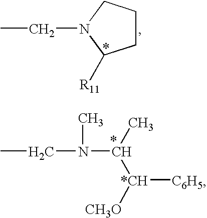

where
R₁₁ is C₁-C₄-alkyl, phenyl, (C₁-C₄-alkyl)₂NCH₂—, (C₁-C₄-alkyl)₂NCH₂CH₂—, C₁-C₄-alkoxymethyl or C₁-C₄-alkoxyethyl. R₁₁ is particularly preferably methoxymethyl or dimethylaminomethyl. Quaternization is advantageously carried out using alkyl halides (alkyl iodides), for example methyl iodide.

Compounds of the formula II in which Y is —CH₂—OR can be obtained by firstly acoxylating 1-(C₁-C₄-alkyl)₂NCH₂-2-haloferrocene by means of carboxylic anhydrides, for example acetic acid, to form 1-acyloxy-CH₂-2-haloferrocene (for example 1-acetyloxy-CH₂-2-haloferrocene), and then reacting these intermediates with alcohols in the presence of bases or with alkali metal alkoxides to give 1-RO—CH₂-2-haloferrocene. Compounds of the formula II in which Y is —HCR₅—OR₇ can be obtained in an analogous way by modification of the group Y=—HCR₅—N(C₁-C₄-alkyl)₂ by means of alcohols HOR₇.

The regioselectivity in the metallation in the ortho position relative to the bromine atom for the subsequent introduction of electrophils is surprisingly essentially retained even in the presence of the groups vinyl, methyl, ethyl, —CH₂—OR and (C₁-C₄-alkyl)₂NCH₂—.

The metallation of ferrocenes using alkyllithium or magnesium Grignard compounds is a known reaction which is described, for example, by T. Hayashi et al., Bull. Chem. Soc. Jpn. 53 (1980), pages 1138 to 1151, or in Jonathan Clayden Organolithiums: Selectivity for Synthesis (Tetrahedron Organic Chemistry Series), Pergamon Press (2002). The alkyl in the alkyllithium can contain, for example, from 1 to 4 carbon atoms. Methyllithium and butyllithium are frequently used. Magnesium Grignard compounds are preferably those of the formula (C₁-C₄-alkyl)MgX₀, where X₀ is Cl, Br or I.

The reaction is advantageously carried out at low temperatures, for example from 20 to −100° C., preferably from 0 to −80° C. The reaction time is from about 1 to 20 hours. The reaction is advantageously carried out under inert protective gases, for example nitrogen or noble gases such as helium or argon.

The reaction is advantageously carried out in the presence of inert solvents. Such solvents can be used either alone or as a combination of at least two solvents. Examples are solvents are aliphatic, cycloaliphatic and aromatic hydrocarbons and also open-chain or cyclic ethers. Specific examples are petroleum ether, pentane, hexane, cyclohexane, methylcyclohexane, benzene, toluene, xylene, diethyl ether, dibutyl ether, tert-butyl methyl ether, ethylene glycol dimethyl or diethyl ether, tetrahydrofuran and dioxane.

The halogenation is generally carried out directly after the metallation in the same reaction mixture, with reaction conditions similar to those in the metallation being maintained. For the purposes of the invention, at least equivalent amounts means the use of preferably from 1 to 1.4 equivalents of a halogenating reagent. Halogenating reagents are, for example, halogens (Br₂, I₂), interhalogens (Cl—Br, Cl—I) and aliphatic, perhalogenated hydrocarbons [HCl₃ (iodo form), BrF₂C—CF₂Br or 1,1,2,2-tetrabromoethane] for the introduction of Br or I.

The metallation and the halogenation proceed regioselectively and the compounds of the formula II are obtained in high yields. The reaction is also stereoselective due to the presence of the chiral group Y. Furthermore, if necessary, optical isomers can also be separated at this stage, for example by chromatography using chiral columns.

In process step a), the ferrocene skeleton is once again regioselectively metallated in the same cyclopentadienyl ring in the ortho position relative to the halogen atom in formula II, with metal amides being sufficient to replace the acidic H atom in the ortho position relative to the halogen atom. For the purposes of the invention, at least equivalent amounts means the use of from 1 to 10 equivalents of an aliphatic lithium sec-amide or an X₀Mg sec-amide per CH group in the cyclopentadienyl ring of the ferrocene. X₀ is Cl, Br or iodine.

Aliphatic lithium sec-amide or X₀Mg sec-amide can be derived from secondary amines containing from 2 to 18, preferably from 2 to 12 and particularly preferably from 2 to 10, carbon atoms. The aliphatic radicals bound to the N atom can be alkyl, cycloalkyl or cycloalkylalkyl or be N-heterocyclic rings having from 4 to 12 and preferably from 5 to 7 carbon atoms. Examples of radicals bound to the N atom are methyl, ethyl, n- and i-propyl, n-butyl, pentyl, hexyl, cyclopentyl, cyclohexyl and cyclohexylmethyl. Examples of N-heterocyclic rings are pyrrolidine, piperidine, morpholine, N-methylpiperazine, 2,2,6,6-tetramethylpiperidine and azanorbornane. In a preferred embodiment, the amides correspond to the formula Li—N(C₃-C₄-alkyl)₂ or X₀Mg—N(C₃-C₄-alkyl)₂, where alkyl is in particular i-propyl. In another preferred embodiment, the amide is Li(2,2,6,6-tetramethylpiperidine).

The reaction of process step a) can be carried out in the above-described solvents under the reaction conditions for the preparation of the compounds of the formula II. The compounds of the formula III are generally not isolated, but the reaction mixture obtained is instead preferably used in the subsequent step b).

In the reaction of process step b), at least equivalent amounts or an excess of up to 1.5 equivalents of a compound of the formula Z₁-Halo, sulfur or an organic disulfide are used.

In process step b), radicals X₂ are introduced by reaction with compounds of the formula Z₁-Halo, sulfur or an organic disulfide with replacement of M. For the purposes of the invention, at least equivalent amounts means the use of from 1 to 1.2 equivalents of a reactive compound per reacting ═CM group in the cyclopentadienyl ring. However, it is also possible to use a significant excess of up to 5 equivalents.

The reaction is advantageously carried out at low temperatures, for example from 20 to −100° C., preferably from 0 to −80° C. The reaction is advantageously carried out under an inert protective gas, for example noble gases such as argon or else nitrogen. After addition of the reactive electrophilic compound, the reaction mixture is advantageously allowed to warm to room temperature or is heated to elevated temperatures, for example up to 100° C. and preferably up to 50° C., and is stirred for some time under these conditions in order to complete the reaction.

The reaction is advantageously carried out in the presence of inert solvents. Such solvents can be used either alone or as a combination of at least two solvents. Examples of solvents are aliphatic, cycloaliphatic and aromatic hydrocarbons and also open-chain or cyclic ethers. Specific examples are petroleum ether, pentane, hexane, heptane, cyclohexane, methylcyclohexane, benzene, toluene, xylene, diethyl ether, dibutyl ether, tert-butyl methyl ether, ethylene glycol dimethyl or diethyl ether, tetrahydrofuran and dioxane.

The compounds of the formula IV can be isolated by known methods (extraction, distillation, crystallization, chromatographic methods) and, if appropriate, purified in a manner known per se.

The reaction of process step c) is carried out in a manner similar to the above-described lithiation (by means of alkyllithium) and substitution reactions. It is possible to use equivalent amounts of lithiating reagent or Z₂-Halo compound, sulfur or an organic disulfide or an excess of up to 1.2 equivalents. The metallation is preferably carried out at a temperature of from −80 to about 30° C. The replacement of the metal advantageously takes place firstly at temperatures of from +20 to −100° C. and then, in an after-reaction, with heating to up to 80° C. The abovementioned solvents can be used.

In an alternative process according to the invention, compounds of the formula III are used as starting materials and are reacted with a brominating reagent to form of a compound of the formula V

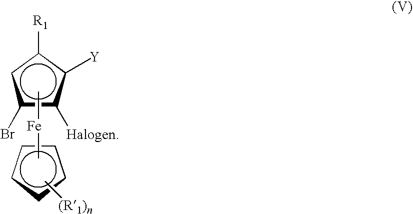

The compound of the formula V can be metallated stepwise (lithiated by means of Li—C₁-C₄-alkyl), with halogen firstly being replaced by, for example, Li. Y is in this case preferably an ortho-directing group. Reaction with a Z₂-Halo compound, sulfur or an organic disulfide then leads to a compound of the formula VI

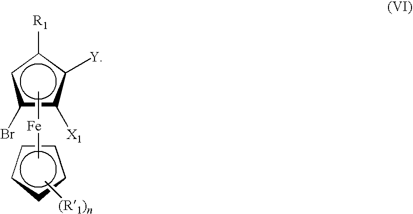

Renewed metallation and subsequent reaction with Z₁-Halo, sulfur or an organic disulfide then leads to a compound of the formula I according to the invention. The reaction conditions and solvents can be similar to those for the above-described process steps, which also applies to the isolation.

Compounds of the formula I in which the phosphino groups X₁ and/or X₂ contain different substituents (additionally P-chiral ligands), for example the groups —PR₃R₄ in which R₃ and R₄ are not identical, can also be prepared by a process in WO 2005/068478. For example, metallated precursors of ferrocenes can be reacted not with Z₁-Halo or with Z₂-Halo but instead with a (Halo)₂PR₃ group so as firstly introduce a —P(Halo)R₃ radical. The halogen atom in this group can then be replaced by a radical R₄ by reaction with LiR₄ or X₀MgR₄.

The compounds of the formula I are obtained in good yields and high purities by means of the process of the invention. The high flexibility for introduction of the groups X₁ and X₂ represents a particular advantage of the two processes since the groups X₁ and X₂ are bound in the reverse order. The choice of groups X₁ and X₂ can thus be matched to the reaction conditions of the process steps.

Compounds of the formula I can be modified in the group Y (introduction of acyloxy and —OR or —R₇ or hydrolysis to —OH as mentioned above), for example as described by T. Hayashi et al., Bull. Chem. Soc. Jpn. 53 (1980), pages 1138 to 1151.

In compounds of the formulae I and IV, a —CH₂—OR, —CH₂—N(C₁-C₄-alkyl)₂ group Y or a C-bonded chiral group Y which directs metals of metallating reagents to the ortho position X₁ can be modified, for example by elimination of amine groups to form a vinyl group. In compounds of the formula I in which R₁ is hydrogen and Y is —CH₂—OR, —CH₂—N(C₁-C₄-alkyl)₂ or a C-bonded chiral group which directs metals of metallating reagents to the ortho position X₁, a radical R₁ which is not hydrogen can be introduced.

The novel compounds of the formula I are ligands for complexes of transition metals, preferably selected from the group of TM8 metals, in particular from the group consisting of Ru, Rh and Ir, which are excellent catalysts or catalyst precursors for asymmetric syntheses, for example the asymmetric hydrogenation of prochiral, unsaturated, organic compounds. If prochiral unsaturated organic compounds are used, a very large excess of optical isomers can be induced in the synthesis of organic compounds and a high chemical conversion can be achieved in short reaction times. The enantioselectivities and catalyst activities which can be achieved are excellent and in the case of an asymmetric hydrogenation considerably higher than those achieved using the known “Kagan ligands” mentioned at the outset. Furthermore, such ligands can also be used in other asymmetric addition or cyclization reactions.

The invention further provides complexes of metals selected from the group of transition metals, for example TM8 metals, with one of the compounds of the formula I as ligands.

Possible metals are, for example, Cu, Ag, Au, Ni, Co, Rh, Pd, Ir, Ru and Pt. Preferred metals are rhodium and iridium and also ruthenium, platinum and palladium.

Particularly preferred metals are ruthenium, rhodium and iridium.

The metal complexes can, depending on the oxidation number and coordination number of the metal atom, contain further ligands and/or anions. They can also be cationic metal complexes. Analogous metal complexes and their preparation are widely described in the literature.

The metal complexes can, for example, correspond to the general formulae VII and VIII

A₁MeLᵣ (VII),

(A₁MeLᵣ)^{(z+)}(E⁻)_{z} (VIII),

where A₁ is one of the compounds of the formula I,
L represents identical or different monodentate, anionic or nonionic ligands or L represents identical or different bidentate, anionic or nonionic ligands;
r is 2, 3 or 4 when L is a monodentate ligand or n is 1 or 2 when L is a bidentate ligand;
z is 1, 2 or 3;
Me is a metal selected from the group consisting of Rh, Ir and Ru, with the metal having the oxidation state 0, 1, 2, 3 or 4;
E⁻ is the anion of an oxo acid or complex acid; and
the anionic ligands balance the charge of the oxidation state 1, 2, 3 or 4 of the metal.

The above-described preferences and embodiments apply to the compounds of the formula I.

Monodentate nonionic ligands can, for example, be selected from the group consisting of olefins (for example ethylene, propylene), solvating solvents (nitriles, linear or cyclic ethers, unalkylated or N-alkylated amides and lactams, amines, phosphines, alcohols, carboxylic esters, sulfonic esters), nitrogen monoxide and carbon monoxide.

Suitable polydentate anionic ligands are, for example, allyls (allyl, 2-methallyl) or deprotonated 1,3-diketo compounds such as acetylacetonate.

Monodentate anionic ligands can, for example, be selected from the group consisting of halide (F, Cl, Br, I), pseudohalide (cyanide, cyanate, isocyanate) and anions of carboxylic acids, sulfonic acids and phosphonic acids (carbonate, formate, acetate, propionate, methyl-sulfonate, trifluoromethylsulfonate, phenylsulfonate, tosylate).

Bidentate nonionic ligands can, for example, be selected from the group consisting of linear or cyclic diolefins (for example hexadiene, cyclooctadiene, norbornadiene), dinitriles (malononitrile), unalkylated or N-alkylated carboxylic diamides, diamines, diphosphines, diols, dicarboxylic diesters and disulfonic diesters.

Bidentate anionic ligands can, for example, be selected from the group consisting of anions of dicarboxylic acids, disulfonic acids and diphosphonic acids (for example oxalic acid, malonic acid, succinic acid, maleic acid, methylenedisulfonic acid and methylene-diphosphonic acid).

Preferred metal complexes also include complexes in which E is —Cl⁻, —Br⁻, —I⁻, ClO₄⁻, CF₃SO₃⁻, CH₃SO₃⁻, HSO₄⁻, (CF₃SO₂)₂N⁻, (CF₃SO₂)₃C⁻, tetraarylborates such as B(phenyl)₄⁻, B[bis(3,5-trifluoromethyl)phenyl]₄⁻, B[bis(3,5-dimethyl)phenyl]₄⁻, B(C₆F₅)₄⁻ and B(4-methylphenyl)₄⁻, BF₄⁻, PF₆⁻, SbCl₆⁻, AsF₆⁻ or SbF₆⁻.

Very particularly preferred metal complexes which are particularly suitable for hydrogenations correspond to the formulae IX and X,

[A₁Me₂Y₁Z] (IX),

[A₁Me₂Y₁]⁺E₁⁻ (X),

where
A₁ is one of the compounds of the formula I;
Me₂ is rhodium or iridium;
Y₁ is two olefins or one diene;

### Z is Cl, Br or I; and

E₁⁻ is the anion of an oxo acid or complex acid.

The above-described embodiments and preferences apply to the compounds of the formula I.

An olefin Y₁ can be a C₂-C₁₂—, preferably C₂-C₆— and particularly preferably C₂-C₄-olefin. Examples are propene, 1-butene and in particular ethylene. The diene can contain from 5 to 12 and preferably from 5 to 8 carbon atoms and can be an open-chain, cyclic or polycyclic diene. The two olefin groups of the diene are preferably connected by one or two CH₂ groups. Examples are 1,4-pentadiene, cyclopentadiene, 1,5-hexadiene, 1,4-cyclohexadiene, 1,4- or 1,5-heptadiene, 1,4- or 1,5-cycloheptadiene, 1,4- or 1,5-octadiene, 1,4- or 1,5-cyclooctadiene and norbornadiene. Y is preferably two ethylenes or 1,5-hexadiene, 1,5-cyclooctadiene or norbornadiene.

In the formula IX, Z is preferably Cl or Br. Examples of E₁ are BF₄⁻, ClO₄⁻, CF₃SO₃⁻, CH₃SO₃⁻, HSO₄⁻, B(phenyl)₄⁻, B[bis(3,5-trifluoromethyl)phenyl]₄⁻, PF₆⁻, SbCl₆⁻, AsF₆⁻ or SbF₆⁻.

The metal complexes of the invention are prepared by methods known in the literature (see also U.S. Pat. No. 5,371,256, U.S. Pat. No. 5,446,844, U.S. Pat. No. 5,583,241 and E. Jacobsen, A. Pfaltz, H. Yamamoto (Eds.), Comprehensive Asymmetric Catalysis I to III, Springer Verlag, Berlin, 1999, and references cited therein).

The metal complexes of the invention are homogeneous catalysts or catalyst precursors which can be activated under the reaction conditions, which can be used for asymmetric addition reactions onto prochiral, unsaturated, organic compounds.

The metal complexes can, for example, be used for asymmetric hydrogenation (addition of hydrogen) of prochiral compounds having carbon-carbon or carbon-heteroatom double bonds. Such hydrogenations using soluble homogeneous metal complexes are described, for example, in Pure and Appl. Chem., Vol. 68, No. 1, pages 131-138 (1996). Preferred unsaturated compounds to be hydrogenated contain the groups C═C, C═N and/or C═O According to the invention, complexes of ruthenium, rhodium and iridium are preferably used for the hydrogenation.

The invention further provides for the use of the metal complexes of the invention as homogeneous catalysts for preparing chiral organic compounds, preferably for the asymmetric addition of hydrogen onto a carbon-carbon or carbon-heteroatom double bond in prochiral organic compounds.

A further aspect of the invention is a process for preparing chiral organic compounds by asymmetric addition of hydrogen onto a carbon-carbon or carbon-heteroatom double bond in prochiral organic compounds in the presence of a catalyst, which is characterized in that the addition reaction is carried out in the presence of catalytic amounts of at least one metal complex according to the invention.

Preferred prochiral, unsaturated compounds to be hydrogenated can contain one or more, identical or different C═C, C═N and/or C═O groups in open-chain or cyclic organic compounds, with the C═C, C═N and/or C═O groups being able to be part of a ring system or being exocyclic groups. The prochiral unsaturated compounds can be alkenes, cycloalkenes, heterocycloalkenes or open-chain or cyclic ketones, α,β-diketones, α- or β-ketocarboxylic acids or their α,β-ketoacetals or -ketals, esters and amides, ketimines and kethydrazones.

Some examples of unsaturated organic compounds are acetophenone, 4-methoxy-acetophenone, 4-trifluoromethylacetophenone, 4-nitroacetophenone, 2-chloroacetophenone, corresponding unsubstituted or N-substituted acetophenonebenzylimines, unsubstituted or substituted benzocyclohexanone or benzocyclopentanone and corresponding imines, imines from the group consisting of unsubstituted or substituted tetrahydroquinoline, tetrahydropyridine and dihydropyrrole and unsaturated carboxylic acids, esters, amides and salts such as α- and if appropriate β-substituted acrylic acids or crotonic acids. Preferred carboxylic acids are those of the formula

R₀₁—CH═C(R₀₂)—C(O)OH

and also their salts, esters and amides, where R₀₁ is C₁-C₆-alkyl, C₃-C₈-cycloalkyl which may be unsubstituted or bear from 1 to 4 C₁-C₆-alkyl, C₁-C₆-alkoxy, C₁-C₆-alkoxy-C₁-C₄-alkoxy substituents or C₆-C₁₀-aryl which may be unsubstituted or bear from 1 to 4 C₁-C₆-alkyl, C₁-C₆-alkoxy, C₁-C₆-alkoxy-C₁-C₄-alkoxy substituents and preferably phenyl and R₀₂ is linear or branched C₁-C₆-alkyl (for example isopropyl) or cyclopentyl, cyclohexyl, phenyl or protected amino (for example acetylamino) which may be unsubstituted or substituted as defined above.

The process of the invention can be carried out at low or elevated temperatures, for example temperatures of from −20 to 150° C., more preferably from −10 to 100° C. and particularly preferably from 10 to 80° C. The optical yields are generally better at a relatively low temperature than at higher temperatures.

The process of the invention can be carried out at atmospheric pressure or superatmospheric pressure. The pressure can be, for example, from 10⁵ to 2×10⁷ Pa (pascal). Hydrogenations can be carried out at atmospheric pressure or under superatmospheric pressure.

Catalysts are preferably used in amounts of from 0.0001 to 10 mol %, particularly preferably from 0.001 to 10 mol % and very particularly preferably from 0.01 to 5 mol %, based on the compound to be hydrogenated.

The preparation of the ligands and catalysts and the hydrogenation can be carried out without solvents or in the presence of an inert solvent, with it being possible to use one solvent or mixture of solvents. Suitable solvents are, for example, aliphatic, cycloaliphatic and aromatic hydrocarbons (pentane, hexane, petroleum ether, cyclohexane, methylcyclohexane, benzene, toluene, xylene), aliphatic halogenated hydrocarbons (methylene chloride, chloroform, dichloroethane and tetrachloroethane), nitriles (acetonitrile, propionitrile, benzonitrile), ethers (diethyl ether, dibutyl ether, t-butyl methyl ether, ethylene glycol dimethyl ether, ethylene glycol diethyl ether, diethylene glycol dimethyl ether, tetra-hydrofuran, dioxane, diethylene glycol monomethyl or monoethyl ether), ketones (acetone, methyl isobutyl ketone), carboxylic esters and lactones (ethyl or methyl acetate, valerolactone), N-substituted lactams (N-methylpyrrolidone), carboxamides (dimethylamide, dimethylformamide), acyclic ureas (dimethylimidazoline) and sulfoxides and sulfones (dimethyl sulfoxide, dimethyl sulfone, tetramethylene sulfoxide, tetramethylene sulfone) and alcohols (methanol, ethanol, propanol, butanol, ethylene glycol monomethyl ether, ethylene glycol monoethyl ether, diethylene glycol monomethyl ether) and water. The solvents can be used either alone or in mixtures of at least two solvents.

The reaction can be carried out in the presence of cocatalysts, for example quaternary ammonium halides (tetrabutylammonium iodide) and/or in the presence of protic acids, for example mineral acids (see, for example, U.S. Pat. No. 5,371,256, U.S. Pat. No. 5,446,844 and U.S. Pat. No. 5,583,241 and EP-A-0 691 949). The presence of fluorinated alcohols, for example 1,1,1-trifluoroethanol, can likewise promote the catalytic reaction.

The metal complexes used as catalysts can be added as separately prepared isolated compounds or can be formed in situ prior to the reaction and then be mixed with the substrate to be hydrogenated. It can be advantageous for ligands to be additionally added in the case of the reaction using isolated metal complexes or an excess of ligands to be used in the case of the in-situ preparation. The excess can be, for example, from 1 to 6 and preferably from 1 to 2 mol, based on the metal compound used for the preparation.

The process of the invention is generally carried out by placing the catalyst in a reaction vessel and then adding the substrate, if appropriate reaction auxiliaries and the compound to be added on and then starting the reaction. Gaseous compounds to be added on, for example hydrogen or ammonia, are preferably introduced under pressure. The process can be carried out continuously or batchwise in various types of reactor.

The chiral, organic compounds obtained according to the invention are active substances or intermediates for the preparation of such substances, in particular in the field of production of flavors and odorous substances, pharmaceuticals and agrochemicals.

The following examples illustrate the invention.

### STARTING MATERIALS AND ABBREVIATIONS

1-[(Dimethylamino)eth-1-yl]ferrocene is commercially available.

### 1-[(Dimethylamino)eth-1-yl]-2-bromoferrocene of the formula

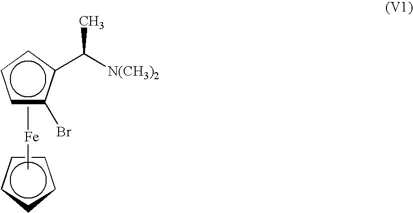

is prepared as described in the literature: J. W Han et al. Helv. Chim. Acta, 85 (2002) 3848-3854. The compound will hereinafter be referred to as V1.
The reactions are carried out under inert gas (argon).
The reactions and yields are not optimized.
Abbreviations: TMP=2,2,6,6-tetramethylpiperidine; TBME=tert-butyl methyl ether; DMF: N,N-dimethylformamide, THF=tetrahydrofuran, EA=ethyl acetate, Me=methyl, Et=ethyl, i-Pr=i-propyl, nbd=norbornadiene, Cy=cyclohexyl, n-BuLi=n-butyllithium, eq.=equivalents.

### A) Preparation of ferrocene-1,2-diphosphines

### EXAMPLE A1

### Preparation of 1-(dimethylaminoeth-1-yl)-2-bromo-3-dicyclohexylphosphino-ferrocene (compound A1) of the formula

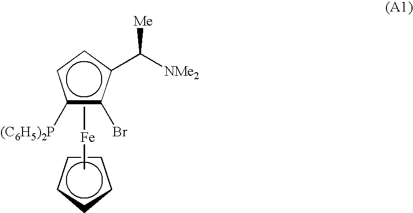

40.0 ml (64.7 mmol) of a 1.6 M solution of n-BuLi in hexane is added dropwise to a solution of 11.2 ml (66.9 mmol) of TMP in 100 ml of THF at 0° C. and the mixture is stirred for 1 hour. This solution is added dropwise to a solution of 7.46 g (22.3 mmol) of compound V1 in 60 ml of THF at −40° C. and the mixture is stirred for 1.5 hours. The mixture is cooled to −78° C., 6.00 ml (26.9 mmol) of Cy₂PCl are added and the mixture is stirred at −78° C. for another 2.5 hours. Water is added, the organic phase is dried over Na₂SO₄, the solvent is evaporated and the crude product is purified by chromatography (silica gel 60; eluent=acetone/heptane 1:2). This gives the compound A1 as a brown oil (9.75 g, 18.4 mmol, 82% of theory). ¹H-NMR (300 MHz, C₆D₆, δ/ppm), characteristic signals: 4.05 (s, 5H); 4.03 (d, 1H); 3.98 (d, 1H); 3.95 (q, 1H); 2.45-2.30 (m, 1H); 2.16 (s, 6H); 2.05-1.00 (m, 21H); 1.35 (d, 3H). ³¹P-NMR (121 MHz, C₆D₆, δ/ppm): −9.3 (s).

### EXAMPLE A2

### Preparation of 1-(dimethylaminoeth-1-yl)-2-bromo-3-diphenylphosphinoferrocene (compound A2) of the formula

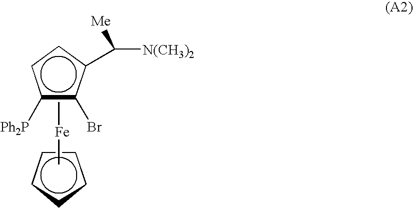

46.4 ml (74.2 mmol) of a 1.6 M solution of n-BuLi in hexane are added dropwise to a solution of 13.0 ml (76.8 mmol) of TMP in 100 ml of THF at 0° C. and the mixture is stirred for 1 hour. This solution is added dropwise to a solution of 8.61 g (25.6 mmol) of compound V1 in 70 ml of THF at −40° C. and the mixture is stirred for 2.5 hours. The mixture is cooled to −78° C., 6.20 ml (33.3 mmol) of Ph₂PCl are added and the mixture is stirred for another 1.5 hours. Water is then added, the mixture is extracted with TBME, the organic phase is dried over Na₂SO₄, the solvent is evaporated, the crude product is purified by chromatography (silica gel 60; eluent=EA/NEt₃ 100:2) and recrystallized from methanol. This gives compound A2 as an orange solid in a yield of 73%.

¹H-NMR (C₆D₆, 300 MHz), characteristic signals: 7.70-7.55 (m, 2H); 7.40-7.30 (m, 2H); 7.15-6.95 (m, 6H); 4.03 (s, 5H); 3.96 (d, 1H); 3.90 (q, 1H); 3.65 (d, 1H); 2.19 (s, 6H); 1.31 (d, 3H). ³¹P-NMR (121 MHz, C₆D₆, δ/ppm): −18.4 (s).

### EXAMPLE A3

### Preparation of 1-(dimethylaminoeth-1-yl)-2-bromo-3-di-ortho-anisylphosphinoferrocene (compound A3) of the formula

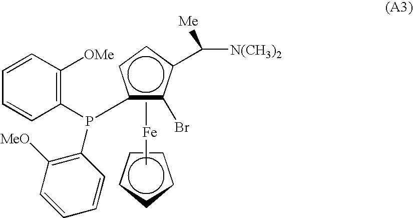

34.5 ml (86 mmol) of a 2.5 M solution of n-BuLi in hexane are added dropwise to a solution of 15.5 ml (90.0 mmol) of TMP in 50 ml of THF at 0° C. and the mixture is stirred for 1 hour. This solution is added dropwise to a solution of 10 g (30 mmol) of compound V1 in 70 ml of THF at −40° C. and the mixture is stirred for 3.5 hours at a temperature ranging from −40 to −30° C. The mixture is then cooled to −78° C., 8.9 g (31.5 mmol) of di-ortho-anisylphosphine chloride are added and the mixture is stirred for another 2 hours. Water is added, the mixture is extracted with TBME, the organic phase is dried over Na₂SO₄, the solvent is evaporated and the crude product is purified by chromatography (silica gel 60; eluent=heptane/TBME 1:1). This gives the compound A3 as an orange solid in a yield of 74%. ¹H-NMR (C₆D₆, 300 MHz), characteristic signals: 7.40-7.30 (m, 1H); 7.25-7.15 (m, 1H); 7.15-7.00 (m, 2H); 6.95-6.85 (m, 1H); 6.75-6.65 (m, 1H); 6.65-6.55 (m, 1H); 6.45-6.35 (m, 1H); 4.17 (s, 5H); 4.03 (d, 1H); 3.95 (q, 1H); 3.76 (d, 1H); 3.47 (s, 3H); 3.11 (s, 3H); 2.24 (s, 6H); 1.37 (d, 3H). ³¹P-NMR (121 MHz, C₆D₆, δ/ppm): −44.2 (s).

### EXAMPLE A4

### Preparation of 1-(dimethylaminoeth-1-yl)-2-bromo-3-diethylphosphinoferrocene (compound A4) of the formula

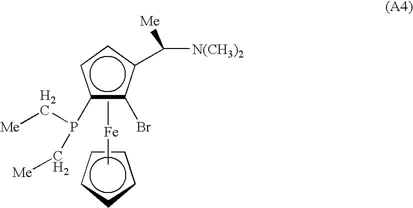

34.5 ml (86 mmol) of a 2.5 M solution of n-BuLi in hexane are added dropwise to a solution of 15.5 ml (90.0 mmol) of TMP in 50 ml of THF at 0° C. and the mixture is stirred for 1 hour. This solution is added dropwise to a solution of 10 g (30 mmol) of compound V1 in 50 ml of THF at −40° C. and the mixture is stirred for 3.5 hours at a temperature ranging from −40 to −30° C. The mixture is then cooled to −78° C., 3.95 ml (31.5 mmol) of (ethyl)₂PCl are added and the mixture is stirred for another 2 hours. Water is added, the mixture is extracted with TBME, the organic phase is dried over Na₂SO₄, the solvent is evaporated, the crude product is purified by chromatography (silica gel 60; eluent=heptane/TBME 1:1 containing 1% of NEt₃). This gives compound A4 in a yield of 95% as an orange oil which crystallizes overnight. ¹H-NMR (C₆D₆, 300 MHz), characteristic signals: 4.01 (s, 5H), 3.96-3.86 (m, 3H), 2.14 (s, 6H), 1.8-1.35 (m, 4H), 1.33 (d, 3H), 1.21-1.10 (m, 3H), 0.97-0.88 (m, 3H). ³¹P-NMR (121 MHz, C₆D₆, δ/ppm): −27.9 (s).

### EXAMPLE A5

### Preparation of 1-(dimethylaminoeth-1-yl)-2,3-dibromoferrocene (compound A5) of the formula

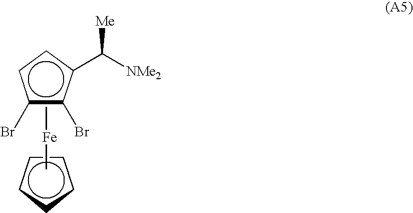

An Li-TMP solution [composition: 0.37 ml (2.2 mmol) of TMP and 1.28 ml (2.05 mmol) of n-BuLi (1.6 M in hexane) in 2.5 ml of THF] is added dropwise to a solution of 246 mg (0.733 mmol) of compound V1 in 1 ml of THF at −78° C. while stirring and the reaction mixture is stirred firstly at −78° C. for 10 minutes and subsequently at −40° C. for 3 hours. After cooling back down to −78° C., 0.27 ml (2.2 mmol) of 1,2-dibromotetrafluoroethane is added and the mixture is stirred at −78° C. for another 1.5 hours. 3 ml of water are then added and the reaction mixture is extracted with TBME. The organic phases are collected, dried over sodium sulfate and the solvent is distilled off under reduced pressure on a rotary evaporator. Purification by means of column chromatography (silica gel 60; eluent=acetone) gives compound A5 as an orange-brown oil in a yield of 62%. ¹H-NMR (C₆D₆, 300 MHz), characteristic signals: 4.17 (m, 1H), 3.93 (s, 5H, cyclopentadiene), 3.71 (q, 1H), 3.64 (m, 1H), 2.06 (s, 6H, N(CH₃)₂), 1.17 (d, 3H, C(NMe₂)CH₃).

### EXAMPLE A6

### Preparation of 1-(dimethylaminoeth-1-yl)-2-diphenylphosphino-3-bromoferrocene (compound A6) of the formula

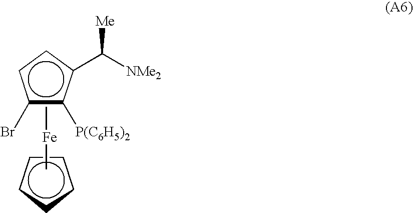

0.27 ml (0.432 mmol) of n-BuLi (1.6 M in hexane) is added dropwise to a solution of 171 mg (0.411 mmol) of compound A5 in 2 ml of TBME at −78° C. while stirring and the reaction mixture is stirred at −78° C. for 2 hours. 0.092 ml (0.49 mmol) of chlorodiphenylphosphine is then added and the reaction mixture is stirred at −78° C. for 0.5 hour. The cooling is removed and the reaction mixture is stirred overnight. The work-up is carried out by addition of water and extraction with methylene chloride. The organic phases are collected, dried over sodium sulfate and the solvent is distilled off under reduced pressure on a rotary evaporator. Column chromatography (silica gel 60; eluent is firstly EA, then acetone) gives two main fractions: the second fraction contains compound A6 as orange-yellow product. ¹H-NMR (C₆D₆, 300 MHz), characteristic signals: 7.65-7.59 (m, 2H), 7.38-7.32 (m, 2H), 7.11-7.0 (m, 6H), 4.02 (s, 5H, cyclopentadiene), 2.18 (s, 6H, N(CH₃)₂), 1.32 (d, 3H, C(NMe₂)CH₃). ³¹P-NMR(C₆D₆, 121 MHz): −14.4.

### EXAMPLE A7

### Preparation of 1-vinyl-2-bromoferrocene (compound A7) of the formula

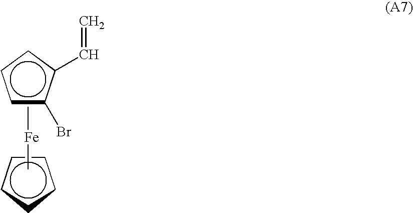

5.21 g (15.5 mmol) of the compound V1 in 30 ml of acetic anhydride are heated at 135° C. for 4 hours while stirring. After cooling, the mixture is extracted with water/toluene. The organic phases are collected, dried over sodium sulfate and the solvent is distilled off under reduced pressure (20 torr) on a rotary evaporator. If necessary, the crude product is purified by chromatography (silica gel 60, eluent=heptane). The compound A7 is obtained as a reddish brown oil in a yield of 80%. ¹H-NMR (C₆D₆, 300 MHz) characteristic signals: δ=6.89 (m, 1H), 5.38 (m, 1H), 5.08 (m, 1H), 4.28 (m, 1H), 4.16 (m, 1H), 3.94 (s, 5H), 3.80 (m, 1H).

### EXAMPLE A8

### Preparation of 1-ethyl-2-bromoferrocene (compound A8) of the formula

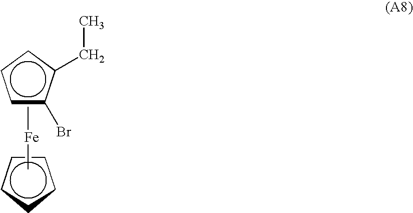

A solution of 7.1 g (24.4 mmol) of the compound A7 in 35 ml of THF is stirred vigorously in the presence of 0.7 g of catalyst (5% Rh/C, Engelhard) in a hydrogen atmosphere (atmospheric pressure) until no more hydrogen is consumed. The reaction mixture is then placed under argon and the catalyst is filtered off. After washing with a little THF, the filtrate is freed completely of the solvent on a rotary evaporator. The product A8 is obtained as an orange oil in quantitative yield. ¹H-NMR (C₆D₆, 300 MHz) characteristic signals: δ=4.24 (m, 1H), 3.96 (s, 5H), 3.77 (m, 1H), 3.71 (m, 1H), 2.42-2.23 (m, 2H), 1.05 (t, 3H).

### EXAMPLE A9

### Preparation of 1-ethyl-2-bromo-3-diphenylphosphinoferrocene (compound A9) of the formula

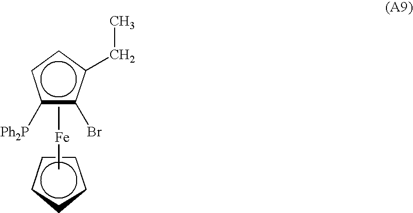

The compound A9 is prepared by a method similar to Example A2. After lithiation of the compound A8 by means of Li-TMP, the lithiated intermediate is reacted with diphenylphosphine chloride. Purification by chromatography (silica gel 60; eluent=heptane/EA 20:1) gives the title compound as a brown solid (yield 59%). ¹H-NMR (C₆D₆, 300 MHz) characteristic signals: δ=7.62 (m, 2H), 7.38 (m, 2H), 7.1-6.9 (m, 6H), 3.99 (s, 5H), 3.94 (m, 1H), 3.59 (m, 1H), 2.47-2.26 (m, 2H), 1.07 (t, 3H). ³¹P-NMR(C₆D₆, 121 MHz): δ −18.2 (s)

### B) Preparation of ferrocene-1,2-diphosphines

### EXAMPLE B1

### Preparation of 1-(dimethylaminoeth-1-yl)-2-diphenylphosphino-3-dicyclohexylphosphinoferrocene (compound B1) of the formula [starting from A1 (method a)]

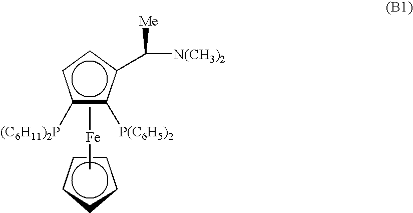

1.02 g (1.92 mmol, 1.0 eq.) of compound A1 are dissolved in 20 ml of TBME and then cooled to 0° C. 1.41° ml (2.30 mmol, 1.2 eq) of n-butyllithium solution (1.6 M in hexane) are then added dropwise. The mixture is stirred at this temperature for a further 2 hours, then cooled to −78° C. and 0.50 ml (2.69 mmol, 1.4 eq) of diphenylphosphine chloride is added over a period of 15 minutes. The mixture is stirred overnight, with the reaction mixture warming to room temperature. 20 ml of water are added and the organic phase is separated off. After addition of saturated sodium hydrogencarbonate solution to the aqueous phase, it is extracted again with TBME. The combined organic phases are dried over sodium sulfate and the solvent is then evaporated to dryness under reduced pressure on a rotary evaporator. The orange-brown foam obtained is purified by chromatography [silica gel, acetone:heptane (1:10)]. This gives 531 mg (39%) of the title compound in the form of an orange, solid foam. ¹H-NMR (C₆D₆, 300 MHz), characteristic signals: 8.03 (m, 2H) 7.67 (m, 2H), 7.22-7.02 (m, 6H), 4.30-4.26 (m, 2H), (4.14 (s, 5H), 1.92 (s, 6H, N(CH₃)₂), 1.02 (d, 3H). ³¹P-NMR(C₆D₆, 121 MHz): −11.9 to −13.3 (two overlapping signals).

### EXAMPLE B2

### Preparation of compound B1 [starting from compound A6 (method b)]

102 mg (0.196 mmol) of compound A6 in 4 ml of TBME are cooled to −78° C. 0.13 ml (0.21 mmol) of n-butyl-Li (1.6 M solution in hexane) is slowly added dropwise while stirring. After stirring for 10 minutes, 58 mg (0.25 mmol) of dicyclohexylphosphine chloride are added and the mixture is stirred at −78° C. for a further one hour. The cooling bath is then removed and the mixture is stirred overnight. 2 ml of water are added and the organic phase is separated off. After addition of saturated sodium hydrogencarbonate solution to the aqueous phase, it is extracted again with TBME. The combined organic phases are dried over sodium sulfate and freed of the solvent under reduced pressure on a rotary evaporator. Purification by chromatography [silica gel, acetone:heptane (1:10)] gives the compound B1 which is identical to the compound obtained in Example B1.

### EXAMPLE B3

### Preparation (method a) of 1-(dimethylaminoeth-1-yl)-2-(methyl-t-butylphosphino)-3-dicyclohexylphosphinoferrocene (compound B2) of the formula

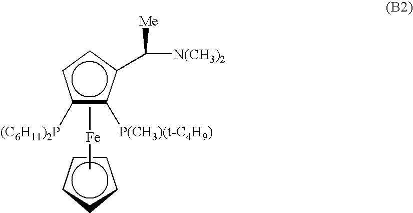

1.04 g (1.97 mmol, 1.0 eq.) of compound A1 are dissolved in 7 ml of TBME and then cooled to 0° C. 1.36 ml (2.17 mmol, 1.1 eq.) of n-butyllithium solution (1.6 M in hexane) are added dropwise and the mixture is stirred at this temperature for 1 hour (solution A). 416 mg (3 mmol, 1.1 eq.) of racemic tert-butylmethylphosphine chloride are dissolved in 3 ml of TBME and cooled to 0° C. (solution B). Solution B is added dropwise to solution A over a period of 10 minutes. The cooling bath is then removed and the reaction mixture is stirred at room temperature for another 2 hours. 10 ml of water are added while cooling, the organic phase is isolated, dried over sodium sulfate and the solvent is removed on a rotary evaporator. The brown oil obtained is purified by chromatography (silica gel 60; eluent=TBME). This gives two diastereomers as orange solids.

### Diastereomer 1:

¹H-NMR (C₆D₆, 300 MHz), characteristic signals: 4.38 (m, 1H), 4.29 (m, 1H), 4.17 (m, 1H) 4.09 (s, 5H), 2.1 (s, 6H, N(CH₃)₂), 1.95 (m, 3H), 1.46 (d, 9H), 1.17 (d, 3H). ³¹P-NMR(C₆D₆, 121 MHz): −8.9 (s), −12.9 (s).

### Diastereomer 2:

¹H-NMR (C₆D₆, 300 MHz), characteristic signals: 4.25 (m, 2H), 4.13 (s, 5H, cyclopentadiene), 3.90 (m, 1H), 2.03 (s, 6H, N(CH₃)₂), 1.58 (d, 3H), 1.44 (d, 9H), 1.09 (d, 3H). ³¹P-NMR(C₆D₆, 121 MHz): −8.8 (d), −14.2 (d).

### EXAMPLE B4

### Preparation of Compound B2 (Method b)

1.36 ml (2.17 mmol) of a 1.6 M solution of n-BuLi in hexane are added dropwise to a solution of 1.04 g (1.97 mmol) of compound A1 in 7 ml of TBME at 0° C. and the mixture is stirred for 1 hour. This solution is added dropwise to a solution of 345 mg (2.17 mmol) of t-butylPCl₂ in 3 ml of TBME at 0° C. The ice bath is removed, the mixture is stirred for a further one hour, cooled back down to 0° C. and 0.92 ml (2.76 mmol) of a 3 M solution of MeMgCl in THF is added. The ice bath is removed and the mixture is stirred overnight. The reaction mixture is admixed with water, filtered through kieselguhr and the aqueous phase is extracted with TBME. The combined organic phases are dried over Na₂SO₄, the solvent is evaporated and the crude product is purified by chromatography (SiO₂, acetone:heptane (1:10)). This gives compound B2 as an orange solid (epimer 1: 350 mg, 0.63 mmol, 32%; epimer 2: 59 mg, 0.11 mmol, 5%). The ratio of epimers alters during the separation by chromatography.

### Epimer 1:

¹H-NMR (300 MHz, C₆D₆, δ/ppm): 4.45-4.35 (m, 1H); 4.35-4.25 (m, 1H); 4.20-4.10 (m, 1H); 4.09 (s, 5H); 2.40-1.10 (m, 22H); 2.10 (s, 6H); 1.95 (d, 3H); 1.46 (d, 9H); 1.17 (d, 3H).

³¹P-NMR (121 MHz, C₆D₆, δ/ppm): −8.9 (s); −12.9 (s).

### Epimer 2:

¹H-NMR (300 MHz, C₆D₆, δ/ppm): 4.30-4.20 (m, 2H); 4.13 (s, 5H); 3.90 (q, 1H); 2.50-1.00 (m, 22H); 2.03 (s, 6H); 1.59 (d, 3H); 1.44 (d, 9H); 1.09 (d, 3H). ³¹P-NMR (121 MHz, C₆D₆, 6/ppm): −8.7 (d); −14.2 (d).

### EXAMPLE B5

### Preparation of 1-(dimethylaminoeth-1-yl)-2-(bis-4-trifluoromethylphenyl)phosphino-3-dicyclohexylphosphinoferrocene (compound B3) of the formula

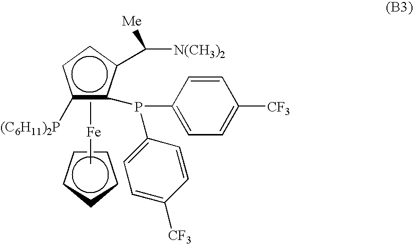

2.9 ml (4.65 mmol) of n-BuLi (1.6 M in hexane) are added dropwise to a solution of 2 g (3.87 mmol) of compound A1 in 40 ml of TBME at 0° C. After stirring at the same temperature for 1.5 hours, 2.16 ml (6.06 mmol) of bis(4-trifluoromethylphenyl)phosphine chloride are slowly added dropwise at 0° C. After stirring for 1 hour, the cooling bath is removed and the temperature is allowed to rise to room temperature. After stirring for 4.5 hours, the reaction mixture is admixed with water and extracted with TBME. The organic phases are collected, dried over sodium sulfate and the solvent is distilled off under reduced pressure on a rotary evaporator. Column chromatography (silica gel 60; eluent=dichloromethane/EA 10:1 containing 1% of triethylamine) gives the compound B3 as an orange solid in a yield of 64%. ¹H-NMR (300 MHz, C₆D₆, δ/ppm) characteristic signals: 7.90-7.80 (m, 2H); 7.60-7.30 (m, 6H); 4.25-4.10 (br m, 1H); 4.23 (d, 1H); 4.12 (d, 1H); 4.06 (s, 5H); 2.20-0.90 (m, 22H); 1.68 (s, 6H); 1.99 (d, 3H). ³¹P-NMR (121 MHz, C₆D₆, δ/ppm): −11.3 (br m); −16.7 (br m).

### EXAMPLE B6

### Preparation of 1-(dimethylaminoeth-1-yl)-2-bis(3,5-dimethyl-4-methoxyphenyl)-phosphinodicyclohexylphosphinoferrocene (compound B4) of the formula

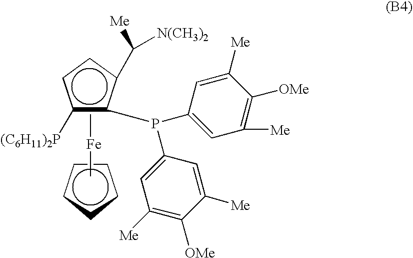

3.37 ml (5.39 mmol) of n-BuLi (1.6 M in hexane) are added dropwise to a solution of 2.39 g (4.49 mmol) of compound A1 in 40 ml of TBME at 0° C. After stirring at the same temperature for 1.5 hours, 2.29 g (6.80 mmol) of bis(3,5-dimethyl-4-methoxyphenyl)phosphine chloride are slowly added dropwise at 0° C. After stirring for 1 hour, the cooling bath is removed and the temperature is allowed to rise to room temperature. After stirring for 4.5 hours, the reaction mixture is admixed with water and a little sodium hydrogencarbonate and extracted with dichloromethane. The organic phases are collected, dried over sodium sulfate and the solvent is distilled off under reduced pressure on a rotary evaporator. Column chromatography (silica gel 60; eluent=dichloromethane/EA 10:1 containing 1% of triethylamine) gives the title compound as an orange solid in a yield of 37%. ¹H-NMR (300 MHz, C₆D₆, δ/ppm) characteristic signals: 7.80 (d, 2H); 7.47 (d, 2H); 4.35-4.25 (m, 2H); 4.21 (s, 5H); 4.10-4.50 (br m, 1H); 3.45 (s, 3H); 3.37 (s, 3H); 2.40-0.85 (m, 22H); 2.27 (2, 6H); 2.18 (s, 6H); 2.04 (s, 6H); 1.02 (d, 3H). ³¹P-NMR (121 MHz, C₆D₆, δ/ppm): −12.2 (br, m); −14.4 (br, m).

### EXAMPLE B7

### Preparation of i-(dimethylaminoeth-1-yl)-2-diphenylphosphino-3-diphenylphosphinoferrocene (compound B5) of the formula

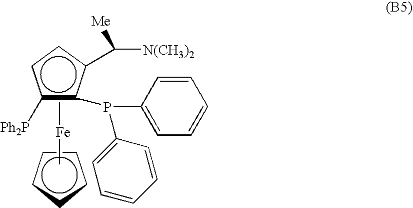

0.73 ml (1.2 mmol) of n-BuLi (1.6 M in hexane) is added dropwise to a solution of 0.52 g (1.0 mmol) of the compound A2 in 10 ml of TBME at 0° C. After stirring at the same temperature for 1.5 hours, 0.26 ml (1.4 mmol) of diphenylphosphine chloride are slowly added dropwise at 0° C. After stirring for 1 hour, the cooling bath is removed and the temperature is allowed to rise to room temperature. After stirring for 2.5 hours, the reaction mixture is extracted with water and dichloromethane. The organic phases are collected, dried over sodium sulfate and the solvent is distilled off under reduced pressure on a rotary evaporator. Column chromatography (silica gel 60; eluent=dichloromethane/EA 4:1 containing 1% of triethylamine) gives compound B5 as an orange solid in a yield of 66%. ¹H-NMR (300 MHz, C₆D₆, δ/ppm) characteristic signals: 7.90-7.75 (m, 2H); 7.60-7.40 (m, 4H); 7.30-6.80 (m, 12H); 4.33 (d, 1H); 4.13 (d, 1H); 4.01 (s, 5H); 4.00-4.15 (m, 1H); 1.89 (s, 6H); 1.03 (d, 3H). ³¹P-NMR (121 MHz, C₆D₆, δ/ppm): −13.3 (d); −23.2 (d).

### EXAMPLE B8

### Preparation of 1-(dimethylaminoeth-1-yl)-2-dicyclohexylphosphino-3-diphenylphosphinoferrocene (compound B6) of the formula

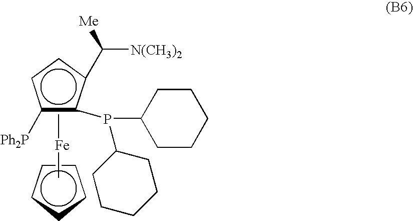

The compound B6 is prepared by a method similar to Example B7. Dicyclohexylphosphine chloride is added in place of diphenylphosphine chloride. Purification by column chromatography (silica gel 60; eluent=dichloromethane/EA 4:1 containing 1% of triethylamine) gives the title compound as an orange solid in a yield of 40%. ¹H-NMR (300 MHz, C₆D₆, δ/ppm) characteristic signals: 7.75-7.65 (m, 2H); 7.45-7.35 (m, 2H); 7.15-6.95 (m, 6H); 4.35 (d, 1H); 4.35-4.20 (br m, 1H); 4.17 (d, 1H); 3.91 (s, 5H); 3.30-0.60 (m, 22H); 2.18 (s, 6H); 1.15 (d, 3H). ³¹P-NMR (121 MHz, C₆D₆, δ/ppm): −4.1 (s); −19.9 (br, s).

### EXAMPLE B9

### Preparation of 1-(dimethylaminoeth-1-yl)-2-bis(3,5-dimethyl-4-methoxyphenyl)-phosphino-3-diphenylphosphinoferrocene (compound B7) of the formula

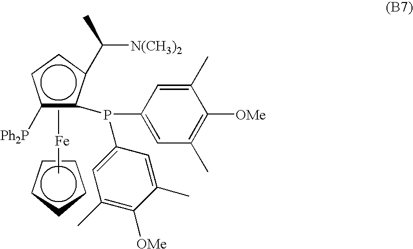

The compound B7 is prepared by a method similar to Example B7. bis(3,5-Dimethyl-4-methoxyphenyl)phosphine chloride is added in place of diphenylphosphine chloride. Purification by column chromatography (silica gel 60; eluent=dichloromethane/EA 4:1 containing 1% of triethylamine) gives the title compound as an orange solid in a yield of 74%. ¹H-NMR (300 MHz, C₆D₆, δ/ppm) characteristic signals: 7.70-7.55 (m, 4H); 7.42 (d, 2H); 7.15-7.05 (m, 4H); 6.95-6.80 (m, 4H); 4.31 (d, 1H); 4.13 (d, 1H); 4.09 (s, 5H); 3.80-3.65 (m, 1H); 3.41 (s, 3H); 3.31 (s, 3H); 2.18 (s, 6H); 2.12 (s, 6H); 2.03 (s, 6H); 1.03 (d, 3H). ³¹P-NMR (121 MHz, C₆D₆, δ/ppm): −15.9 (d); −22.4 (d).

### EXAMPLE B10

### Preparation of 1-vinyl-2-bis(3,5-dimethyl-4-methoxyphenyl)phosphino-3-diphenylphosphinoferrocene (compound B8) of the formula

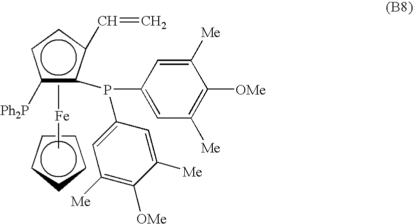

250 mg (0.34 mmol) of the compound B7 are stirred in 1 ml of acetic anhydride at 140° C. for 2 hours. After cooling, the acetic anhydride is distilled off under reduced pressure. The residue is taken up in ethyl acetate. After washing with saturated sodium hydrogencarbonate solution and subsequently with water, the organic phase is dried over sodium sulfate and evaporated on a rotary evaporator. Purification by chromatography (silica gel 60; eluent=EA/heptane 1:10 containing 2% of triethylamine) gives the compound B8 as an orange foam in a yield of 72%. ¹H-NMR (300 MHz, C₆D₆, δ/ppm) characteristic signals: 7.65-6.85 (div. m, 14 aromatic H), 6.71 (m, 1H), 5.36 (m, 1H), 4.92 (m, 1H), 4.66 (m, 1H), 4.11 (m, 1H), 4.06 (s, 5H), 3.37 (s, 3H), 3.29 (s, 3H), 2.11 (s, 6H), 2.08 (s, 6H). ³¹P-NMR (121 MHz, C₆D₆, δ/ppm): −18.8 (d); −21.4 (d).

### EXAMPLE B11

### Preparation of 1-(dimethylaminoeth-1-yl)-2-diethylphosphino-3-diphenylphosphinoferrocene (compound B9) of the formula

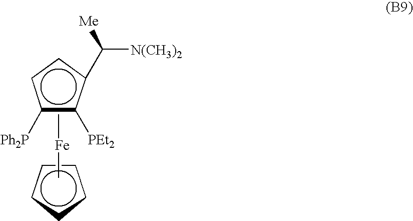

The compound B9 is prepared by a method similar to Example B7. Diethylphosphine chloride is added in place of diphenylphosphine chloride. Purification by chromatography (silica gel 60; eluent=dichloromethane/EA 2:1 containing 1% of triethylamine) gives the title compound as a yellow solid in a yield of 55%. ¹H-NMR (300 MHz, C₆D₆, δ/ppm) characteristic signals: 7.65-7.55 (m, 2H); 7.40-7.30 (m, 2H); 7.15-6.95 (m, 6H); 4.30-4.20 (m, 2H); 3.96 (s, 5H); 3.86 (d, 1H); 2.85-2.65 (m, 1H); 2.50-2.30 (m, 1H); 2.15 (s, 6H); 1.80-1.60 (m, 1H); 1.60-1.45 (m, 1H); 1.40-1.20 (m, 3H); 1.10 (d, 3H); 1.10-0.95 (m, 3H). ³¹P-NMR (121 MHz, CD₃OD, δ/ppm): −20.1 (d); −20.9 (d).

### EXAMPLE B12

### Preparation of 1-(dimethylaminoeth-1-yl)-2-difurylphosphino-3-diphenylphosphinoferrocene (compound B10) of the formula

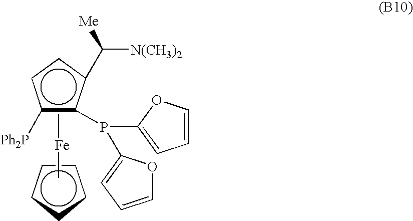

The compound B10 is prepared by a method similar to Example B7. Di-ortho-furylphosphine chloride is added in place of diphenylphosphine chloride. Purification by chromatography (silica gel 60; eluent=dichloromethane/EA 3:1 containing 1% of triethylamine) gives the title compound as a yellow solid in a yield of 68%. ¹H-NMR (300 MHz, C₆D₆, δ/ppm): 7.65-7.50 (m, 2H); 7.48 (s, 1H); 7.35-7.25 (m, 2H); 7.15-7.00 (m, 6H); 6.98 (s, 1H); 6.40-6.35 (m, 2H); 6.20-6.15 (m, 1H); 6.00-5.95 (m, 1H); 4.35-4.25 (m, 1H); 4.15 (s, 5H); 4.15-4.05 (m, 1H); 3.97 (d, 1H); 1.93 (s, 6H); 1.08 (d, 3H). ³¹P-NMR (121 MHz, C₆D₆, δ/ppm): −19.8 (d); −58.4 (d).

### EXAMPLE B13

### Preparation of 1-(dimethylaminoeth-1-yl)-2-diethylphosphino-3-di-ortho-anisylphosphinoferrocene (compound B11) of the formula

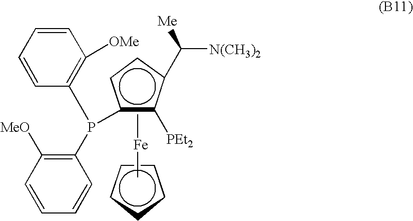

2.6 ml (4.14 mmol) of n-BuLi (1.6 M in hexane) are added dropwise to a solution of 2 g (3.45 mmol) of the compound A3 in 60 ml of TBME at 0° C. After stirring at the same temperature for 3 hours, 0.645 g (5.18 mmol) of diethylphosphine chloride is slowly added dropwise at 0° C. After stirring for 1 hour, the cooling bath is removed and the temperature is allowed to rise to room temperature. After stirring for 2.5 hours, the reaction mixture is extracted with water and dichloromethane. The organic phases are collected, dried over sodium sulfate and the solvent is distilled off under reduced pressure on a rotary evaporator. Column chromatography (silica gel 60; eluent=heptane/EA 2:1 containing 1% of triethylamine) gives compound B11 as an orange solid in a yield of 72%. ¹H-NMR (300 MHz, C₆D₆, δ/ppm) characteristic signals: 7.35-7.25 (m, 1H); 7.15-7.00 (m, 3H); 6.89 (t, 1H); 6.70 (t, 1H); 6.65-6.55 (m, 1H); 6.45-6.35 (m, 1H); 4.40-4.25 (m, 2H); 4.10-4.00 (m, 1H); 4.07 (s, 5H); 3.51 (s, 3H); 3.10 (s, 3H); 3.05-2.90 (m, 1H); 2.65-2.45 (m, 1H); 2.22 (s, 6H); 1.85-1.70 (m, 1H); 1.70-1.45 (m, 1H); 1.45-1.15 (m, 3H); 1.17 (d, 3H); 1.15-0.95 (m, 3H). ³¹P-NMR (121 MHz, C₆D₆, δ/ppm): −19.6 (s); −46.7 (s).

### EXAMPLE B14

### Preparation of 1-(dimethylaminoeth-1-yl)-2-dimethylphosphino-3-di-ortho-anisylphosphinoferrocene (compound 12) of the formula

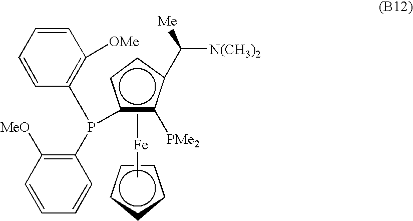

2.6 ml (4.14 mmol) of n-BuLi (1.6 M in hexane) are added dropwise to a solution of 2 g (3.45 mmol) of the compound A3 in 40 ml of THF at 0° C. After stirring at the same temperature for 2 hours, the reaction mixture is slowly transferred through a canula by application of pressure into a flask containing a solution of 0.36 ml (4.14 mmol) of PCl₃ in 80 ml of THF which is stirred at −70° C. The cooling is then removed, the temperature is allowed to rise to room temperature and the mixture is cooled back down to −70° C. before 11.5 ml (34.5 mmol) of methylmagnesium chloride (3M in THF) are added dropwise. The cooling is removed and the mixture is stirred overnight at room temperature. After cooling to 0° C., the reaction mixture is admixed with water. Saturated aqueous ammonium chloride solution is subsequently added at room temperature and the mixture is extracted with EA. The organic phases are collected, dried over sodium sulfate and the solvent is distilled off under reduced pressure on a rotary evaporator. Column chromatography (silica gel 60; eluent=EA/heptane 2:1 containing 1% of triethylamine) gives compound B12 as an orange foam in a yield of 50%. ¹H-NMR (300 MHz, C₆D₆, δ/ppm) characteristic signals: 7.29-6.38 (various m, 8 aromatic H); 4.33 (m, 1H), 4.27 (m, 1H), 4.10 (s, 5H), 3.48 (s, 3H), 3.10 (s, 3H), 2.20 (s, 6H), 1.98 (d, 3H), 1.26 (d, 3H), 1.15 (d, 3H). ³¹P-NMR (121 MHz, C₆D₆, δ/ppm): −47.3 (d); −49.7 (d).

### EXAMPLE B15

### Preparation of 1-(dimethylaminoeth-1-yl)-2-diphenylphosphino-3-diethylphosphinoferrocene (compound 13) of the formula

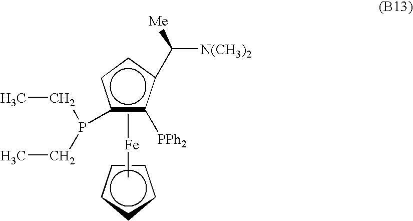

The compound B13 is prepared from compound A4 using a method similar to Example B7. Purification by chromatography (silica gel 60; eluent=heptane/EA 10:1 containing 1% of NEt₃) gives compound B13 as an orange powder in a yield of 54%. ¹H-NMR (300 MHz, C₆D₆, δ/ppm) characteristic signals: 7.86-7.02 (various m, 10 aromatic H); 4.24 (m, 1H), 4.20 (m, 1H), 4.13 (s, 5H), 3.45 (q, 1H), 1.89 (s, 6H), 0.94 (d, 3H). ³¹P-NMR (121 MHz, C₆D₆, δ/ppm): −12.6 (d); −28.8 (d).

### EXAMPLE B16

### Preparation of 1-ethyl-2-diethylphosphino-3-diphenylphosphinoferrocene (compound B14) of the formula

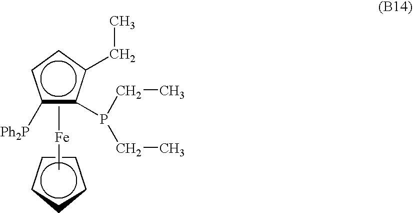

The compound B14 is prepared from compound A9 using a method similar to Example B7. Purification by chromatography (silica gel 60; eluent=heptane/EA 30:1) gives compound B14 as an orange solid in a yield of 50%. ³¹P-NMR(C₆D₆, 121 MHz): δ −20.4 (d), −23.5 (d).

### EXAMPLE B17

### Preparation of 1-(dimethylaminoeth-1-yl)-2-isopropylthio-3-diphenylphosphino-ferrocene (compound B15) of the formula

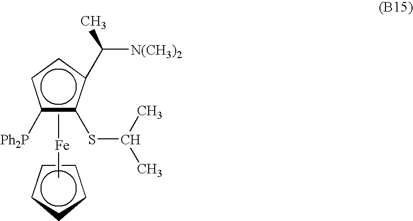

0.72 ml (1.15 mmol) of a solution of n-BuLi in hexane is added dropwise to a solution of 500 mg (0.96 mmol) of compound A2 in 10 ml of TBME at 0° C. and the mixture is stirred for 1 hour. 0.21 ml (1.34 mmol) of (i-Pr)SS(i-Pr) is added and the mixture is stirred for another 2.5 hours. The reaction mixture is admixed with water and aqueous Na₂CO₃ solution (10%), the organic phase is dried over Na₂SO₄, the solvent is evaporated and the crude product is purified by chromatography [SiO₂, TBME:heptane:NEt₃ (150:100:1.5)]. This gives the compound B15 as a yellow solid (368 mg, 715 mmol, 74%). ¹H-NMR (300 MHz, C₆D₆, δ/ppm): 7.75-7.65 (m, 2H); 7.50-7.35 (m, 2H); 7.15-6.95 (m, 6H); 4.23 (d, 1H); 4.21 (q, 1H); 4.01 (d, 1H); 3.97 (s, 5H); 3.17 (sept, 1H); 2.16 (s, 6H); 1.23 (d, 3H); 1.17 (d, 3H); 0.97 (d, 3H). ³¹P-NMR (121 MHz, C₆D₆, δ/ppm): −22.8 (s).

### C) Preparation of Metal Complexes

### EXAMPLE C1

5.1 mg (0.0136 mmol) of [Rh(nbd)₂]BF₄ and 10.4 mg (0.0163 mmol) of compound B1 from Example B1 are weighed into a Schlenk vessel provided with a magnetic stirrer and the air is displaced by means of vacuum and argon. Addition of 0.8 ml of degassed methanol while stirring gives an orange solution of the metal complex (catalyst solution). ³¹P-NMR: (121 MHz, CD₃OD, δ/ppm): 45.8 (d), 44.5 (d), 42.4 (broad signal), 41.2 (broad signal).

### D) Use Examples

### EXAMPLES D1-D20

### Hydrogenation of Dimethyl Itaconate (DMI)

In a vessel provided with a magnetic stirrer, 95 mg (0.6 mmol) of dimethyl itaconate are dissolved in 2 ml of methanol and the air is displaced by means of vacuum and argon. 0.2 ml of the solution from Example B1 is added dropwise to this solution (ratio of Rh to substrate=1:175). The argon is taken off by means of vacuum and the vessel is connected to a hydrogen supply (1 bar). The hydrogenation is started by switching on the stirrer. The uptake of hydrogen ends after less than 10 minutes. Conversion and enantiomeric excess (ee) are determined by gas chromatography using a chiral column (Lipodex E): the conversion is quantitative and the ee is 95.5%.

The hydrogenations of further substrates as shown in the following table are carried out in a similar way. The hydrogen pressure is 1 bar in all hydrogenations except in the case of MEA which is hydrogenated at 80 bar in a steel autoclave. All hydrogenations are carried out at 25° C.

TABLE
Substrates

| | | Determination of |
|---|---|---|
| Substrate | Structures | conversion and ee: |
| DMI | 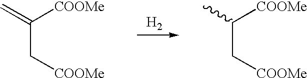 | GC using a chiral column:Lipodex-E |
| MAC | 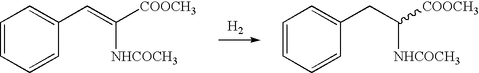 | GC using a chiral column:Chirasil-L-val |
| MAA | 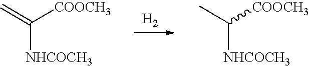 | GC using a chiral column:Chirasil-L-val |
| MCA | 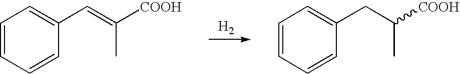 | Firstly derivatization withTMS-diazomethane, thenHPLC using a chiralcolumn:Chiracel-OB |
| cis-EAC | 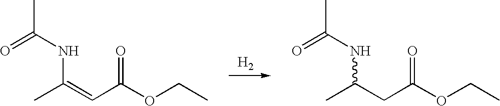 | GC using a chiral column:Betadex-110 |
| trans-EAC | 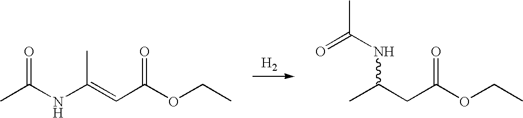 | GC using a chiral column:Betadex-110 |
| MEA | 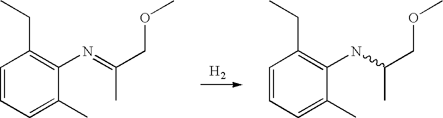 | HPLC using a chiralcolumn:Chiracel-OD-H |

Abbreviations:
ee = enantiomeric excess,
GC = gas chromatography,
TMS = trimethylsilyl,
HPLC = high-pressure liquid chromatography

The results are shown in Table 1 below. In the table:

[S] is the molar substrate concentration; SIC is the substrate/catalyst ratio; t is the hydrogenation time; Solv.=solvent (MeOH=methanol; EtOH=ethanol; Tol=toluene; THF=tetrahydrofuran; DCE=1,2-dichloroethane); metal: metal precursor used in the hydrogenation: Rh^{a)}=[Rh(norbornadiene)₂]BF₄; Rh^{b)}=[Rh(cyclooctadiene)Cl]₂; Ir^{c)}=[Ir(cyclooctadiene)Cl]₂; Conv.=conversion; Conf.=configuration.
Additions: ¹⁾=250 mg of trifluoroethanol are added per 5 ml of solvent; ²⁾ 2.4 mg of tetrabutylammonium iodide and 15 mg of acetic acid are added per 5 ml of solvent.

TABLE 1
Results of hydrogenations

| No. | Ligand | Metal | Substrate | [S] | S/C | Solv. | t [h] | Conv. (%) | ee (%) | Conf. |
|---|---|---|---|---|---|---|---|---|---|---|
| D1 | B1 | Rh^{a)} | DMI | 0.25 | 175 | MeOH | 1 | 100 | 95 | R |
| D2¹⁾ | B2 | Rh^{a)} | cis-EAC | 0.27 | 200 | EtOH | 16 | 85 | 73 | R |
| D3²⁾ | B3 | Ir^{c)} | MEA | 0.25 | 100 | Tol | 18 | 96 | 81 | R |
| D4 | B3 | Rh^{a)} | MAC | 0.25 | 200 | MeOH | 1 | 31 | 78 | S |
| D5²⁾ | B4 | Ir^{c)} | MEA | 0.25 | 100 | Tol | 18 | 92 | 54 | R |
| D6 | B4 | Rh^{a)} | DMI | 0.25 | 200 | MeOH | 1 | 80 | 83 | R |
| D7 | B5 | Rh^{a)} | MAC | 0.25 | 200 | MeOH | 1 | 9 | 65 | S |
| D8 | B5 | Rh^{a)} | DMI | 0.25 | 200 | MeOH | 1 | 41 | 60 | R |
| D9 | B6 | Rh^{a)} | MAC | 0.25 | 200 | MeOH | 1 | 5 | 57 | S |
| D10 | B7 | Rh^{a)} | MAC | 0.25 | 200 | MeOH | 1 | 5 | 42 | S |
| D11 | B8 | Rh^{a)} | MAC | 0.25 | 200 | MeOH | 1 | 12 | 52 | S |
| D12 | B9 | Rh^{a)} | DMI | 0.25 | 200 | MeOH | 1 | 98 | 95 | S |
| D13¹⁾ | B10 | Rh^{a)} | cis-EAC | 0.25 | 200 | EtOH | 17 | 5 | 73 | R |
| D14 | B11 | Rh^{a)} | DMI | 0.25 | 200 | MeOH | 1 | 100 | 99.4 | S |
| D15¹⁾ | B11 | Rh^{a)} | cis-EAC | 0.25 | 200 | EtOH | 17 | 26 | 87 | S |
| D16 | B11 | Rh^{a)} | trans- | 0.34 | 100 | THF | 14 | 100 | 94.5 | R |
| | | | EAC | | | | | | | |
| D17 | B11 | Rh^{b)} | MAA | 0.34 | 100 | DCE | 2 | 100 | 95 | R |
| D18 | B12 | Rh^{a)} | DMI | 0.34 | 100 | EtOH | 2 | 100 | 99 | S |
| D19 | B14 | Rh^{a)} | MAC | 0.4 | 200 | MeOH | 1 | 25 | 77 | S |
| D20 | B15 | Rh^{a)} | MCA | 0.25 | 200 | MeOH | 21 | 41 | 78 | R |

1. A compound of the formula I in the form of an enantiomerically pure diastereomer or a mixture of diastereomers, 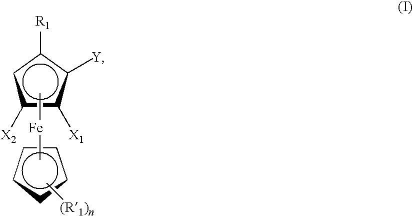
where
R′₁ is C₁-C₄-alkyl, C₆-C₁₀-aryl, C₇-C₁₂-aralkyl or C₇-C₁₂-alkaralkyl and n is 0 or an integer from 1 to 5;
R₁ is a hydrogen atom, halogen, an unsubstituted or —SC₁-C₄-alkyl-, —OC₁-C₄-alkyl-, —OC₆-C₁₀-aryl- or —Si(C₁-C₄-alkyl)₃-substituted hydrocarbon radical having from 1 to 20 carbon atoms or a silyl radical having 3 C₁-C₁₂-hydrocarbon radicals;
Y is vinyl, methyl, ethyl, —CH₂—OR, —CH₂—N(C₁-C₄-alkyl)₂ or a C-bonded chiral group which directs metals of metallating reagents into the ortho position X, or Y is a —CHR₂—OR′₂ group;
R₂ is C₁-C₈-alkyl, C₅-C₈-cycloalkyl, C₆-C₁₀-aryl, C₇-C₁₂-aralkyl or C₇-C₁₂-alkaralkyl;
R′₂ is hydrogen or C₁-C₁₈-acyl;
X₁ and X₂ are each, independently of one another, a P-bonded P(III) substituent, —SH or an S-bonded radical of a mercaptan; and
R is hydrogen, a silyl radical or an aliphatic, cycloaliphatic, aromatic or aromatic-aliphatic hydrocarbon radical which has from 1 to 18 carbon atoms and is unsubstituted or substituted by C₁-C₄-alkyl, C₁-C₄-alkoxy, F or CF₃.

2. The compound as claimed in claim 1, characterized in that the group Y corresponds to the formula —HC*R₅R₆, where * denotes a chiral atom, R₅ is C₁-C₈-alkyl, C₅-C₈-cycloalkyl, phenyl or benzyl, R₆ is —OR₇ or —NR₈NR₉, R₇ is C₁-C₈-alkyl, C₅-C₈-cycloalkyl, phenyl or benzyl and R₈ and R₉ are identical or different and are each C₁-C₈-alkyl, C₅-C₈-cycloalkyl, phenyl or benzyl or R₈ and R₉ together with the N atom form a five- to eight-membered ring.

3. The compound as claimed in claim 2, characterized in that the group Y is 1-methoxyeth-1-yl, 1-dimethylaminoeth-1-yl or 1-(dimethylamino)-1-phenylmethyl.

4. The compound as claimed in claim 1, characterized in that Y is a radical without a chiral a carbon atom, which is bound to the cyclopentadienyl ring via a carbon atom either directly or via a bridging group, preferably methylene, ethylene or an imine group.

5. The compound as claimed in claim 4, characterized in that cyclic radicals selected from among C₁-C₄-alkyl-, (C₁-C₄-alkyl)₂NCH₂—, (C₁-C₄-alkyl)₂NCH₂CH₂—, C₁-C₄-alkoxymethyl- or C₁-C₄-alkoxyethyl-substituted N—, O— or N,O-heterocycloalkyl having a total of 5 or 6 ring atoms are bound to the bridging group or Y is an open-chain radical which is preferably bound via a CH₂ group to the cyclopentadienyl ring, and the radicals are derived from an amino acid or ephedrine.

6. The compound as claimed in claim 5, characterized in that Y is a radical having one of the formulae 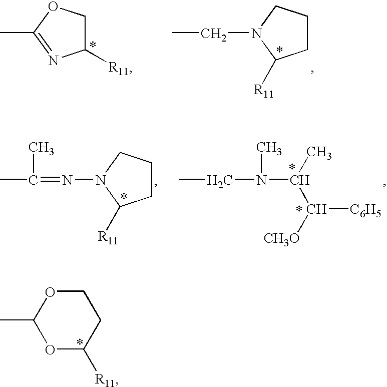
where R₁₁ is C₁-C₄-alkyl, phenyl, (C₁-C₄-alkyl)₂NCH₂—, (C₁-C₄-alkyl)₂NCH₂CH₂—, C₁-C₄-alkoxymethyl or C₁-C₄-alkoxyethyl.

7. The compound as claimed in claim 1, characterized in that Y in the formula I is vinyl, methyl, ethyl, —CH₂—OR, —CH₂—N(C₁-C₄-alkyl)₂, —CHR₅—NR₈R₉ or —CHR₂—OR′₂, where R₂ and R₅ are each, independently of one another, C₁-C₄-alkyl, C₅-C₆-cycloalkyl, phenyl, benzyl or methylbenzyl;
R′₂ is hydrogen or C₁-C₈-acyl or independently has the following meaning of R;
R₈ and R₉ are identical and are each C₁-C₄-alkyl; and
R is C₁-C₆-alkyl, tri(C₁-C₁₈-alkyl)silyl, C₅-C₆-cycloalkyl, C₅-C₆-cycloalkylmethyl, phenyl or benzyl and is unsubstituted or substituted by C₁-C₄-alkyl, C₁-C₄-alkoxy, F or CF₃.

8. The compound as claimed in claim 1, characterized in that the secondary phosphino groups X₁ and X₂ contain two identical or different hydrocarbon radicals which have from 1 to 22 carbon atoms and are unsubstituted or substituted and/or contain heteroatoms selected from the group consisting of O, S, —N═ and N(C₁-C₄-alkyl).

9. The compound as claimed in claim 8, characterized in that a secondary phosphino group contains two identical or different radicals selected from the group consisting of linear or branched C₁-C₁₂-alkyl; unsubstituted or C₁-C₆-alkyl- or C₁-C₆-alkoxy-substituted C₅-C₁₂-cycloalkyl or C₅-C₁₂-cycloalkyl-CH₂—; phenyl, naphthyl, furyl and benzyl; and C₁-C₆-alkyl-, trifluoromethyl-, C₁-C₆-alkoxy-, trifluoromethoxy-, (C₆H₅)₃Si—, (C₁-C₁₂-alkyl)₃Si—, F—, Cl—, Br— or sec-amino-substituted phenyl and benzyl.

10. The compound as claimed in claim 8, characterized in that a sec-phosphino group X₁ or X₂ is cyclic sec-phosphino having one of the formulae 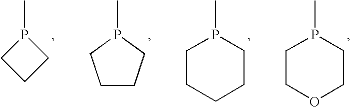
which are unsubstituted or substituted by one or more C₁-C₈-alkyl, C₄-C₈-cycloalkyl, C₁-C₆-alkoxy, C₁-C₄-alkoxy-C₁-C₄-alkyl, phenyl, C₁-C₄-alkylphenyl or C₁-C₄-alkoxyphenyl, benzyl, C₁-C₄-alkylbenzyl or C₁-C₄-alkoxybenzyl, benzyloxy, C₁-C₄-alkylbenzyloxy or C₁-C₄-alkoxybenzyloxy or C₁-C₄-alkylidenedioxyl radicals.

11. The compound as claimed in claim 8, characterized in that X₁ and X₂ are different, preferably different secondary phosphino groups.

12. A process for preparing compounds of the formula I, which comprises the steps:
a) reaction of a compound of the formula II 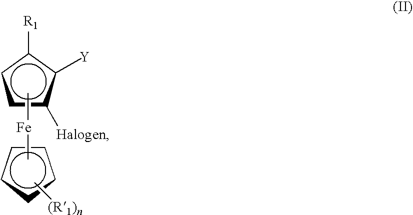
where
Y, R′₁, n and R₁ are as defined above, with the exception of Y=—CHR₂—OR′₂ and R′₂=acyl or hydrogen; and halogen is bromine or iodine, with at least equivalent amounts of an aliphatic lithium sec-amide or a halogen-Mg sec-amide to form a compound of the formula III, 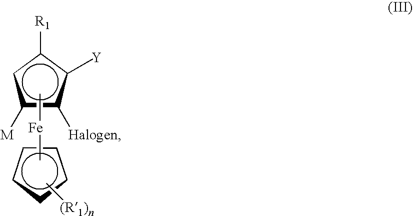
where M is Li or —MgX₃ and X₃ is Cl, Br or I,
b) reaction of a compound of the formula III with a compound of the formula Z₁-Halo, where Halo is Cl, Br or I and Z₁ is a P(III) substituent, or with sulfur or an organic disulfide to introduce the group X₂ and form a compound of the formula IV, 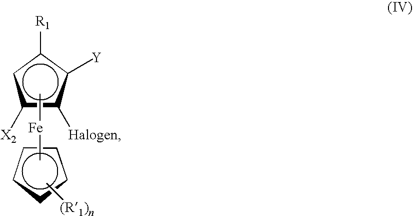
c) reaction of a compound of the formula IV with at least equivalent amounts of alkyllithium or a magnesium Grignard compound and then with at least equivalent amounts of a compound Z₂-Halo, where Halo is Cl, Br or I and Z₂ independently has one of the meanings of Z₁, or with sulfur or an organic disulfide to form a compound of the formula I,
d) and, to prepare compounds of the formula I in which Y is a —CHR₂—OR′₂ group and R′₂ is acyl or hydrogen, reaction of a secondary amino radical in the radical Y with a carboxylic anhydride (acetic anhydride) to form an acyloxy substituent and, if desired, hydrolysis to form a —CHR₂—OH group.

13. A complex of a metal selected from the group of transition metals, preferably the TM8 metals, with one of the compounds of the formula I as ligand.

14. The metal complex as claimed in claim 13, wherein the metal is selected from the group consisting of Cu, Ag, Au, Ni, Co, Rh, Pd, Ir, Ru and Pt.

15. The metal complex according to claim 14 which corresponds to the general formula VII or VIII,
A₁MeLᵣ (VII),
(A₁MeLᵣ)^{(z+)}(E⁻)_{z} (VIII),
where A₁ is one of the compounds of the formula I,
L represents identical or different monodentate, anionic or nonionic ligands or L represents identical or different bidentate, anionic or nonionic ligands;
r is 2, 3 or 4 when L is a monodentate ligand or n is 1 or 2 when L is a bidentate ligand;
z is 1, 2 or 3;
Me is a metal selected from the group consisting of Rh, Ir and Ru, with the metal having the oxidation state 0, 1, 2, 3 or 4;
E⁻ is the anion of an oxo acid or complex acid; and
the anionic ligands balance the charge of the oxidation state 1, 2, 3 or 4 of the metal.

16. The metal complex as claimed in claim 14 which corresponds to the formula IX or X,
[A₁Me₂Y₁Z] (IX),
[A₁Me₂Y₁]⁺E₁⁻ (X),
where
A₁ is one of the compounds of the formula I;
Me₂ is rhodium or iridium;
Y₁ is two olefins or one diene;
Z is Cl, Br or I; and
E⁻ is the anion of an oxo acid or complex acid.

17. A process for preparing chiral organic compounds by asymmetric addition of hydrogen onto a carbon-carbon or carbon-heteroatom double bond in prochiral organic compounds in the presence of a catalyst, characterized in that the addition reaction is carried out in the presence of catalytic amounts of at least one metal complex as claimed in claim 13.

18. The use of the metal complexes as claimed in claim 13 as homogeneous catalysts for preparing chiral organic compounds, preferably for the asymmetric addition of hydrogen onto a carbon-carbon or carbon-heteroatom double bond in prochiral organic compounds.
